(19) United States
(12) Patent Application Publication
(10) Pub. No.: US 2025/0259091 A1
(43) Pub. Date: Aug. 14, 2025

(54) METHODS FOR GENERATING A POLYNOMIAL HISTORY STATE

(71) Applicant: Microsoft Technology Licensing, LLC, Redmond, WA (US)

(72) Inventors: Yuan SU, Redmond, WA (US); Guang Hao LOW, Redmond, WA (US)

(73) Assignee: Microsoft Technology Licensing, LLC, Redmond, WA (US)

(21) Appl. No.: 18/614,546

(22) Filed: Mar. 22, 2024

Related U.S. Application Data
(60) Provisional application No. 63/582,076, filed on Sep. 12, 2023.

(51) Int. Cl. G06N 10/60; G06N 10/20

(52) U.S. Cl. CPC G06N 10/60; G06N 10/20

(57) ABSTRACT

A method for a quantum computer is presented. The method comprises receiving a target matrix comprising only real eigenvalues and block encoding the target matrix. A polynomial approximation is precomputed for a function to be applied to the target matrix. Coefficients are selected for a generating function that match the precomputed polynomial approximation. A polynomial history state is generated, the polynomial history state comprising a superposition of polynomials onto the block encoded target matrix by at least mapping the generating function to a quantum algorithm.

### CROSS REFERENCE TO RELATED APPLICATIONS

This application claims priority to U.S. Provisional Patent Application No. 63/582,076, entitled “METHODS FOR GENERATING A POLYNOMIAL HISTORY STATE”, filed Sep. 12, 2023, the entirety of which is hereby incorporated herein by reference for all purposes.

### BACKGROUND

Quantum computers can manipulate quantum states of exponentially large dimensions with only polynomial resources. This feature underlies the exponential speedups found in promising applications, such as simulating quantum systems, solving systems of linear equations, and factoring integers. These problems often have inputs encoded by matrices such as multi-qubit unitaries and Hamiltonians, and their solutions can be obtained by transforming the exponentially large matrices on a quantum computer using only polynomial resources.

### SUMMARY

A method for a quantum computer is presented. The method comprises receiving a target matrix comprising only real eigenvalues. The target matrix is presented as block encoding. A polynomial approximation is precomputed for a function to be applied to the target matrix. Coefficients are selected for a generating function that matches the precomputed polynomial approximation. A polynomial history state is generated, the polynomial history state comprising a superposition of polynomials onto the block encoded target matrix by at least mapping the generating function to a quantum algorithm.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a flow diagram for an example method of preparing a polynomial history state.

FIG. 2 shows a flow diagram for an example method for preparing a Chebyshev history state with a computer.

FIG. 3 schematically shows a computing system at which one or more processing devices are configured to prepare a polynomial history state.

FIG. 4 shows a flow diagram for an example method for quantum eigenvalue estimation.

FIG. 5 shows a flow diagram for an example method for quantum eigenvalue transformation.

FIG. 6 shows a flow diagram for an example method for a linear-time quantum differential equation algorithm.

FIG. 7 shows a flow diagram for an example method for ground state preparation.

FIG. 8 shows aspects of an example quantum computer.

FIG. 9A illustrates a Bloch sphere, which graphically represents the quantum state of one qubit of a quantum computer.

FIG. 9B shows aspects of an example signal waveform for effecting a quantum-gate operation or measurement in a quantum computer.

FIG. 10 is a schematic illustration of a lattice of physical qubits in one, non-limiting example.

FIG. 11 shows a schematic view of an example classical computer, which can be used to implement the methods described herein.

### DETAILED DESCRIPTION

The estimation and transformation of singular values of high-dimensional matrices may be performed by a quantum computer, in some examples with assistance from a classical computer. In particular, there exists an efficient quantum algorithm, known as the “Quantum Singular Value Transformation” (QSVT), that applies polynomial functions to the singular values of the encoded matrices:

$$A = V \sum {U}^{†} ↦ {p}_{sv} ( A ) = Vp ( \sum ) {U}^{†} , \qquad ( Eq . 1 )$$

QSVT captures diverse quantum algorithms ranging from quantum search to phase estimation and provides a systematic framework to implement such transformations with reduced query complexity. As eigenvalues are different from singular values for non-normal matrices, eigenvalue problems are not directly solvable by existing quantum singular value algorithms.

Closely related to the singular value transformation, it is also known that quantum computers can efficiently estimate singular values of the input matrices, a capability underlying the quantum speedups of factoring integers and elucidating chemical reactions. In particular, this can be solved using the quantum phase estimation algorithm with an optimal number of controlled queries to the operators encoding the input matrix.

However, many problems that arise in practice require transformations and estimations of eigenvalues of the input matrix, not its singular values:

$$A = S Λ {S}^{- 1} ↦ p ( A ) = Sp ( Λ ) {S}^{- 1} . \qquad ( Eq . 2 )$$

Examples where eigenvalue estimations are used include solving linear differential equations, simulating non-Hermitian [symbol] -symmetric Hamiltonians, and fast-forwarding general stochastic matrices. As eigenvalues and singular values are not directly related for non-normal matrices, existing QSVT techniques are generally not applicable to such eigenvalue problems, and there is no unifying framework to solve them on a quantum computer with optimal query complexity.

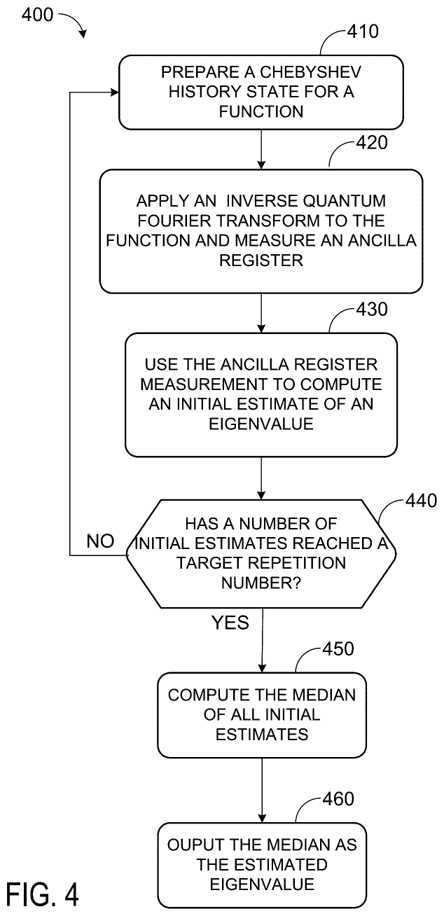

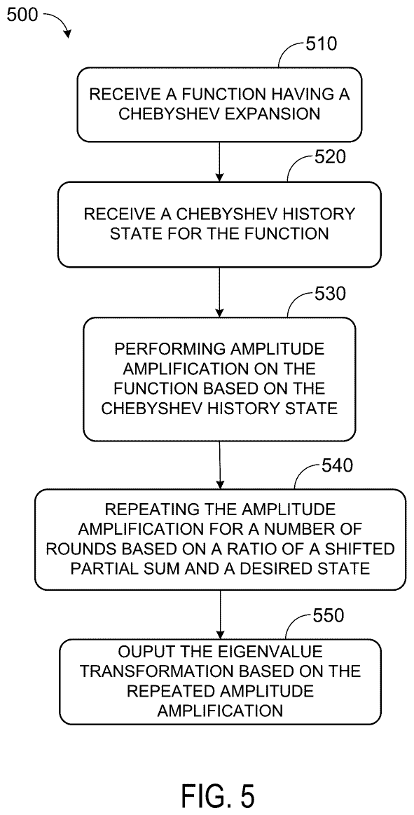

The present disclosure describes a “Quantum EigenValue Estimation” (QEVE) algorithm that estimates the eigenvalues of non-normal input matrices, and a “Quantum EigenValue Transformation” (QEVT) algorithm that applies polynomial transformations to the eigenvalues of non-normal matrices. These are formally described as Theorem 2 (depicted in FIG. 4) and Theorem 3 (depicted in FIG. 5), respectively. For presentational purposes, it is assumed that the input matrix is diagonalizable with only real eigenvalues. However, these assumptions can be relaxed to at least include more general matrices with Jordan forms and to extremal complex eigenvalues.

The QEVE described herein solves the eigenvalue estimation problem for non-normal matrices with a provably optimal query complexity, which naturally reduces to the optimal estimation of singular values that has long been known. This shaves off a polylogarithmic factor over the best previous result. The QEVE of the present disclosure is also conceptually simpler, based on reductions to the optimal scaling quantum linear system algorithm, in contrast to prior approaches based on quantum algorithms for solving linear differential equations.

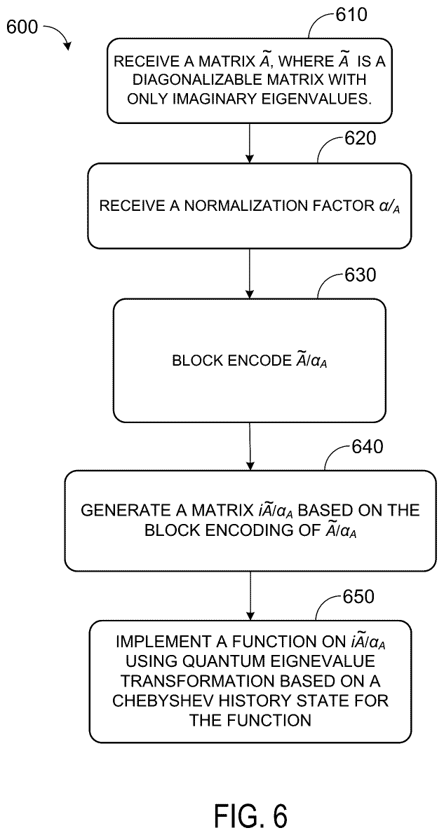

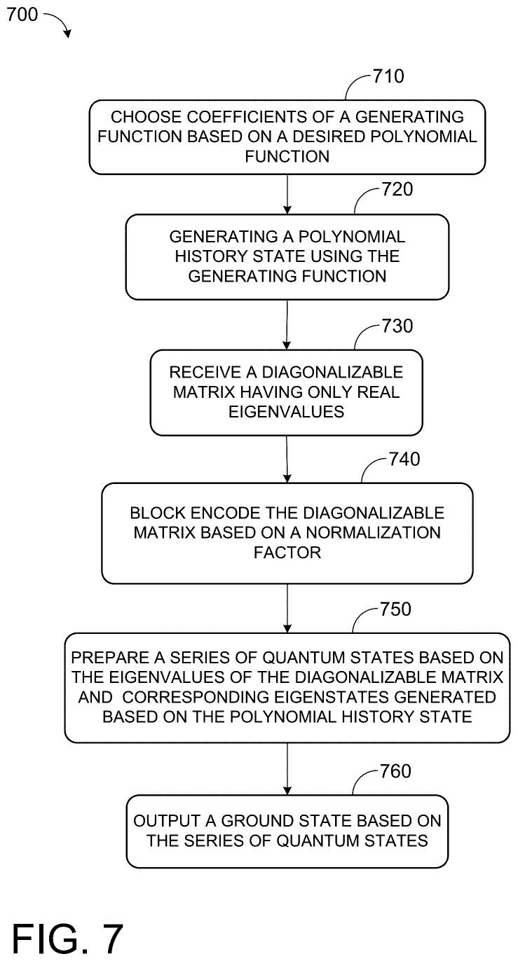

The QEVT described herein implements transformations on the eigenvalues of non-normal input matrices based on the Chebyshev approximation. As Chebyshev approximations provide a close-to-best minimax approximation of functions over a real interval, the query complexity of the disclosed algorithm is nearly optimal by definition, and it is expected that the disclosed algorithm is often optimal for implementing concrete functions of non-normal matrices. As an application, a quantum differential equation algorithm is presented that is based on QEVT with a complexity that scales strictly linearly in the evolution time for an average input matrix, whereas the best previous approach has a query complexity with an extra multiplicative polylog(t) factor. This is formally described as Theorem 4 (depicted in FIG. 6). Herein, the homogeneous case is discussed and an extension to the inhomogenous case is presented. A quantum algorithm has been developed and is presented in Theorem 5 (depicted in FIG. 7) to prepare the ground state of a diagonalizable matrix with real eigenvalues, which recovers the nearly optimal ground state preparation result for Hermitian matrices up to a logarithmic factor.

When performing eigenvalue transformations, some functions are to be applied on the input matrix. Typically, these functions, which cannot be directly implemented, can only be approximately implemented. A polynomial expansion of such a function is performed, as described below. In some examples, this polynomial approximation is done by using Chebyshev polynomials.

In such examples, the function is approximated by a sum of Chebyshev polynomials, which are directly related to the algorithm through a generating function. Herein, most of the examples are described with regard to Chebyshev polynomials and corresponding generating functions. However, a generic generating function can be used to define many different families of polynomials.

By changing the generating function, a different family of polynomials is obtained. Such polynomials can be Taylor polynomials, Faber polynomials etc. The generating function performs a 1 to 1 mapping to a quantum algorithm to generate these polynomials. This is referred to herein as a history state and can be used to generate a superposition of polynomials on the target matrix. Once the history state is obtained, the QFT inverse may be applied using the same step as for regular phase estimation. The QFT inverse register may be measured, and that measurement will be the eigenvalue encoded in a binary format.

As an example, within a superposition, there can be an index J. Attached to this index J will be the J^{th} Chebyshev polynomial of the matrix applied on an input state. Preparing this state with the appropriate coefficients on each of the J components, enables design of an arbitrary approximation. For example, coefficients can be chosen to match precomputed Chebyshev approximations of the function. The coefficients of the polynomials may thus be deliberately chosen for different parts of the superposition. As such, based on J, the sum of the polynomials, when multiplied by their coefficients, matches the precomputed approximation to the transformation problem. Thus, for non-Hermitian matrices, the approach is similar to phase estimation for Hermitian matrices, but depends on generating a history state using a generating function.

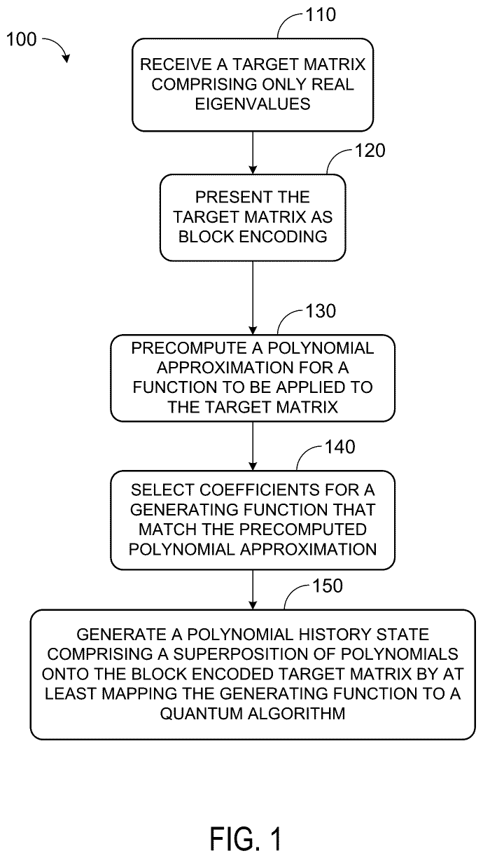

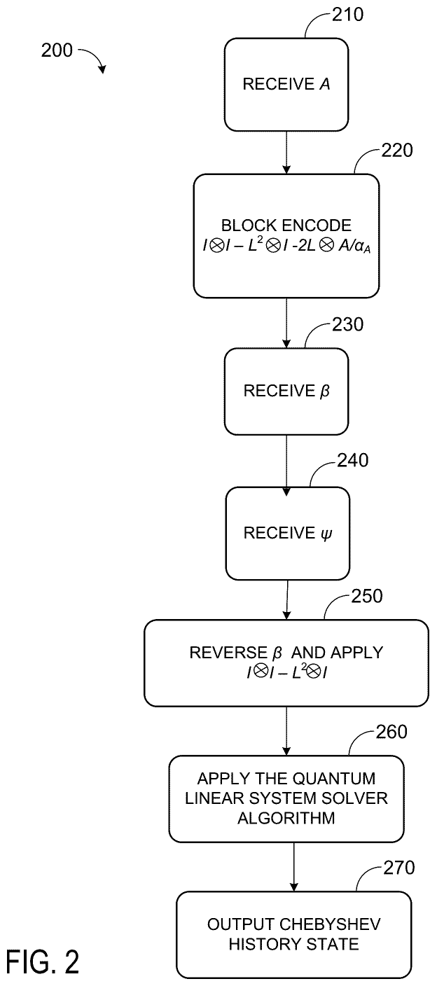

As such, underlying both QEVE and QEVT is an efficient quantum algorithm for generating the Chebyshev history state, which encodes Chebyshev polynomials of the input matrix in superposition. Conventionally, it has been known how to generate such a state via discrete-time quantum walk, which only works for Hermitian input matrices. According to the present disclosure, a method is newly described in Theorem 1 (depicted in FIGS. 1 and 2), based on the generating function, which can efficiently create the Chebyshev history state even for non-normal matrices, and which can be used for eigenvalue estimation and transformation.

The present method can be broadly applied to approximate functions based on other generating functions, such as Faber expansion generally or power series, which like Chebyshev expansion is one special case of Faber expansion, as discussed below. Specifically, consider the expansion of the transformation with respect to a general polynomial basis {pⱼ}ⱼ₌₁^{∞}:

$$p ( A ) = {\sum }_{j = 0}^{n - 1} {β}_{j} {p}_{j} ( A ) . \qquad ( Eq . 3 )$$

Implementing this transformation using conventional methods would have a complexity that scales like ˜Σⱼ₌₀ⁿ⁻¹|βⱼ|, which is often exponential in n and inefficient for applications of practical interest. In contrast, according to the present disclosure, a n-by-n lower shift matrix L is introduced, and used to develop methods to implement

$${\sum }_{j = 0}^{n - 1} {L}^{j} ⊗ {p}_{j} ( A ) = {\sum }_{j = 0}^{∞} {L}^{j} ⊗ {p}_{j} ( A ) = g ( L ⊗ I , I ⊗ A ) \qquad ( Eq . 4 )$$

with a complexity polynomial in n. This is then combined with a subroutine that prepares coefficients βⱼ to efficiently realize the desired transformation. The case where pⱼ(x)=Tⱼ(x) are the Chebyshev polynomials is analyzed in detail and extensions to power series pⱼ(x)=x^{j} are discussed herein. However, the present method applies more broadly to the Faber polynomials that provide a nearly optimal basis for approximating functions on compact subsets of the complex plane, of which the Chebyshev polynomials and power series are two special cases. The Chebyshev history state may thus be generalized to different settings, allowing for generating solutions to different problems. Some example applications include eigenvalue estimation and eigenvalue transformation for solving differential equations, etc.

As an example, let A be a diagonalizable matrix with only real eigenvalues, i.e., A=SΛS⁻¹ where Λ is a real diagonal matrix. Given a real analytic function \tilde{ƒ}: [symbol] → [symbol] and quantum state |ψ [symbol] , then the goal of QEVT is to produce a state that approximates

$$\frac{\tilde{f} ( A ) \vert ψ 〉}{‖ \tilde{f} ( A ) \vert ψ 〉 ‖} . \qquad ( Eq . 5 )$$

For QEVE, it is further assumed that the input state is close to an eigenstate |ψ [symbol] , where A|ψ_{λ} [symbol] =λ|ψ_{λ} [symbol] , and the goal is to estimate λ to a given accuracy with high probability.

To develop quantum algorithms for QEVE and QEVT, certain quantum access to the input matrix A and state |ψ [symbol] is assumed. Specifically, assume that there is a quantum oracle O_{ψ} that prepares |ψ [symbol] :

$${0}_{ψ} \vert 0 〉 = \vert ψ 〉 \qquad ( Eq . 6 )$$

and that A can be block encoded with normalization factor α_{A}, i.e.,

$$( 〈 0 \vert ⊗ I ) {O}_{A} ( \vert 0 〉 ⊗ I ) = \frac{A}{{α}_{A}} \qquad ( Eq . 7 )$$

for some unitary O_{A} acting jointly on the ancilla and the system register. It will be appreciated that a quantum oracle is an unexposed operation that provides input to another algorithm. Note that for this block encoding to be well defined, the following relationship must be true: α_{A}≥∥A∥. However, the present disclosure assumes α_{A}≥2∥A∥ for technical reasons. The goal of the QEVT of the present disclosure thus can be reformulated as applying the rescaled function ƒ(α_{A}(⋅)) to the block encoded matrix, i.e.,

$$\frac{\tilde{f} ( {α}_{A} \cdot ( \frac{A}{{α}_{A}} ) ) \vert ψ 〉}{‖ \tilde{f} ( {α}_{A} \cdot ( \frac{A}{{α}_{A}} ) ) \vert ψ 〉 ‖} . \qquad ( Eq . 8 )$$

In most problems of interest, \tilde{ƒ} cannot directly be implemented on a quantum computer. Instead, the goal is to implement a degree-(n−1) polynomial p(x) that approximates the rescaled function ƒ(⋅)=\tilde{ƒ}(α_{A}(⋅)). It follows from the above discussion that this approximation should be made over the real interval [−1,1]. In this case, Chebyshev approximation provides a nearly optimal solution to the minimax approximation problem, as briefly discussed below.

The Chebyshev polynomials of the first kind are defined over the real interval [−1,1] as

$${T}_{j} ( x ) := cos ( j arccos ( x ) ) . \qquad ( Eq . 9 )$$

Now consider the power series Σⱼ₌₀^{∞}Tⱼ(x)z^{j} generated by the Chebyshev polynomials. Assuming |z|<1, it follows that

$${\sum }_{j = 0}^{∞} {T}_{j} ( x ) {z}^{j} = \frac{1 - zx}{1 + {z}^{2} - 2 zx} . \qquad ( Eq . 10 )$$

This represents a generating function for Chebyshev polynomials. These polynomials may be summed over different degrees according to Equation 8. In Equation 10, the parameter x is the argument that goes into the Chebyshev polynomial, and the parameter z represents the indeterminate whose exponents select the degree of transmission of the polynomial. The generating function derives the j^{th} Chebyshev polynomial from the coefficient of the j exponent (e.g., z^{j}) in the power series.

It is sometimes convenient to rescale the first Chebyshev polynomial by a factor of ½:

$${\tilde{T}}_{j} ( x ) = \{ \begin{matrix}{T}_{j} ( x ) , & j \neq 0 , \\ \frac{1}{2} {T}_{0} ( x ) , & j = 0\end{matrix} . \qquad ( Eq . 11 )$$

In that case, the alternative generating function is as follows

$${\sum }_{j = 0}^{∞} {\tilde{T}}_{j} ( x ) {z}^{j} = \frac{1}{2} + {\sum }_{j = 1}^{∞} {T}_{j} ( x ) {z}^{j} = \frac{1 - {z}^{2}}{2 ( 1 + {z}^{2} - 2 zx )} . \qquad ( Eq . 12 )$$

Equation 12 relates to approximating a function with a Chebyshev expansion. The function of Tⱼ(x) may be expanded into a basis of polynomials, each of which will have an associated coefficient. By using Chebyshev polynomials, the summation may be truncated to a finite order and still yield a very good approximation to the function. How good of an approximation depends on the degree of truncation.

Chebyshev polynomials are orthogonal in the sense that

$${\int }_{- I}^{1} {T}_{j} ( x ) {T}_{k} ( x ) \frac{dx}{\sqrt{1 - {x}^{2}}} = \{ \begin{matrix}0 , & j \neq k , \\ \frac{π}{2} , & j = k \neq 0 , \\ π , & j = k = 0\end{matrix} . \qquad ( Eq . 13 )$$

This implies the uniqueness of the Chebyshev expansion of a function

$$f ( x ) = {\sum }_{j = 0}^{∞} {β}_{j} {T}_{j} ( x ) ⇒ {β}_{j} = \{ \begin{matrix}\frac{2}{π} {\int }_{- 1}^{1} {T}_{j} ( x ) f ( x ) \frac{dx}{\sqrt{1 - {x}^{2}}} , & j \neq 0 , \\ \frac{1}{π} {\int }_{- 1}^{1} {T}_{0} ( x ) f ( x ) \frac{dx}{\sqrt{1 - {x}^{2}}} , & j = 0\end{matrix} . \qquad ( Eq . 14 )$$

Again, the substitution 0=arccos(x) can be applied and these results re-expressed as

$$f ( cos ( θ ) ) = {\sum }_{j = 0}^{∞} {β}_{j} cos ( j θ ) ⇒ {β}_{j} = \{ \begin{matrix}\frac{2}{π} {\int }_{0}^{π} cos ( j θ ) f ( cos ( θ ) ) d θ , & j \neq 0 , \\ \frac{1}{π} {\int }_{0}^{π} f ( cos ( θ ) ) d θ , & j = 0.\end{matrix} \qquad ( Eq . 15 )$$

In other words, the Chebyshev expansion of a function ƒ(x) can be understood as the Fourier expansion of the even function ƒ(cos(θ)). For notational convenience, first expansion coefficient is sometimes rescaled, to define

$${\tilde{β}}_{j} = \{ \begin{matrix}{β}_{j} , & j \neq 0 , \\ 2 {β}_{0} , & j = 0.\end{matrix} \qquad ( Eq . 16 )$$

In other words, the βⱼ are the coefficients that define the target approximation. Equation 16 defines what \tilde{β}ⱼ is in terms of regular β values. First, the superpositions of Chebyshev polynomials are prepared, then the polynomials are paired with corresponding coefficients. As per equation 14, the Chebyshev polynomials are denoted by T and the coefficients are denoted by β. Depending on the specific application, different values for β may be chosen.

Given a specific quantum state, there may be a term that corresponds to an undesired failure case and a second term that correlates to the one state in the first register. Some post processing, such as amplitude amplification, may be applied to the second term to generate the desired sum. The amplitude amplification comes along with a cost that depends on the size of the second term. If the second term is large, the cost is low. If the second term is small, the cost is high. Herein, the second term generally starts reasonably large, and thus minimal effort is required to amplify the second term.

According to the present disclosure, a tool has been developed for solving both QEVE and QEVT, namely a quantum algorithm to efficiently generate a Chebyshev history state of the following form:

$$\frac{\begin{matrix}\vert 0 〉 {\sum }_{l = 0}^{n - 1} \vert l 〉 {\sum }_{k = n - 1 - l}^{n - 1} {\tilde{β}}_{k} {\tilde{T}}_{k + l - n + 1} ( \frac{A}{{α}_{A}} ) \vert ψ 〉 + \\ \vert 1 〉 {\sum }_{l = 0}^{p - 1} \vert l 〉 {\sum }_{k = 0}^{n - 1} {\tilde{β}}_{k} {\tilde{T}}_{k} ( \frac{A}{{α}_{A}} ) \vert ψ 〉\end{matrix}}{\begin{matrix}‖ \vert 0 〉 {\sum }_{l = 0}^{n - 1} \vert l 〉 {\sum }_{k = n - 1 - l}^{n - 1} {\tilde{β}}_{k} {\tilde{T}}_{k + l - n + 1} ( \frac{A}{{α}_{A}} ) \vert ψ 〉 + \\ \vert 1 〉 {\sum }_{l = 0}^{p - 1} \vert l 〉 {\sum }_{k = 0}^{n - 1} {\tilde{β}}_{k} {\tilde{T}}_{k} ( \frac{A}{{α}_{A}} ) \vert ψ 〉 ‖\end{matrix}} . \qquad ( Eq . 17 )$$

This is the state of three quantum registers. The third register is the system register holding the input state, on which certain truncated Chebyshev expansion is performed. The first register indicates whether the Chebyshev expansion has shifted indices, whereas the amount of shifting is further determined by the second register.

As is explained before, Chebyshev polynomials can be efficiently generated by quantum walk when the input matrix A is Hermitian. However, no such mechanism is known for a general input. A technical contribution of the present disclosure is an efficient quantum algorithm that generates the Chebyshev history state even for non-normal matrices, essentially a truncated series of Chebyshev polynomials. As described further herein, such a process may be further generalized beyond Chebyshev polynomials to any suitable polynomials. Specifically, the following is disclosed.

Theorem 1 (Generating a Chebyshev history state). Let A be a diagonalizable matrix with only real eigenvalues, and A=SΛS⁻¹ be its eigenvalue decomposition with condition number κ_{S}=∥S∥∥S⁻¹∥. Let O_{A} be a block encoding of A/α_{A} for some normalization factor α_{A}2∥A∥, O_{γ}|0 [symbol] =|ψ [symbol] be the quantum oracle preparing the initial state, and

$${𝒪}_{\tilde{β}} \vert 0 〉 = \frac{1}{‖ \tilde{β} ‖} {\sum }_{k = 0}^{n - 1} {\tilde{β}}_{k} \vert k 〉$$

be the quantum oracle preparing the coefficients \tilde{β}. Then, the quantum state

$$\frac{\begin{matrix}\vert 0 〉 {\sum }_{l = 0}^{n - 1} \vert l 〉 {\sum }_{k = n - 1 - l}^{n - 1} {\tilde{β}}_{k} {\tilde{T}}_{k + l - n + 1} ( \frac{A}{{α}_{A}} ) \vert ψ 〉 + \\ \vert 1 〉 {\sum }_{l = 0}^{p - 1} \vert l 〉 {\sum }_{k = 0}^{n - 1} {\tilde{β}}_{k} {\tilde{T}}_{k} ( \frac{A}{{α}_{A}} ) \vert ψ 〉\end{matrix}}{\begin{matrix}‖ \vert 0 〉 {\sum }_{l = 0}^{n - 1} \vert l 〉 {\sum }_{k = n - 1 - l}^{n - 1} {\tilde{β}}_{k} {\tilde{T}}_{k + l - n + 1} ( \frac{A}{{α}_{A}} ) \vert ψ 〉 + \\ \vert 1 〉 {\sum }_{l = 0}^{p - 1} \vert l 〉 {\sum }_{k = 0}^{n - 1} {\tilde{β}}_{k} {\tilde{T}}_{k} ( \frac{A}{{α}_{A}} ) \vert ψ 〉 ‖\end{matrix}} \qquad ( Eq . 18 )$$

can be prepared with accuracy E using

$$𝒪 ( {κ}_{s} ( n + p ) log ( \frac{1}{ϵ} ) ) \qquad ( Eq . 19 )$$

queries to controlled-O_{A}, controlled-O_{ψ}, controlled O_{\tilde{β}}, and their inverses, where \tilde{T}ₖ(x) are the rescaled Chebyshev polynomials defined by Equations (9) and (11).

A core idea behind the algorithm presented herein is the use of a matrix version of the Chebyshev generating functions

$${\sum }_{j = 0}^{n - 1} {L}^{j} ⊗ {\tilde{T}}_{j} ( \frac{A}{{α}_{A}} ) = {\sum }_{j = 0}^{∞} {L}^{j} ⊗ {\tilde{T}}_{j} ( \frac{A}{{α}_{A}} ) = \frac{I ⊗ I - {L}^{2} ⊗ I}{2 ( I ⊗ I + {L}^{2} ⊗ I - 2 L ⊗ \frac{A}{{α}_{A}} )} , \qquad ( Eq . 20 )$$

where L is the n-by-n lower shift matrix

$$L = {\sum }_{k = 0}^{n - 2} \vert k + 1 〉 〈 k \vert \qquad ( Eq . 21 )$$

such that Lⁿ=0. Applying it to the (reversal of) initial state

$$\frac{1}{‖ \tilde{β} ‖} {\sum }_{k = 0}^{n - 1} {\tilde{β}}_{k} \vert n - 1 - k 〉$$

and |ψ [symbol] the following is obtained (up to a normalization factor):

$$( {\sum }_{j = 0}^{n - 1} {L}^{j} ⊗ {\tilde{T}}_{j} ( \frac{A}{{α}_{A}} ) ) ( {\sum }_{k = 0}^{n - 1} {\tilde{β}}_{k} \vert n - 1 - k 〉 \vert ψ 〉 ) = {\sum }_{l = 0}^{n - 1} \vert l 〉 {\sum }_{k = n - 1 - l}^{n - 1} {\tilde{β}}_{k} {\tilde{T}}_{k + l - n + 1} ( \frac{A}{{α}_{A}} ) \vert ψ 〉 . \qquad ( Eq . 22 )$$

This is the first term of the desired state. The second term can then be generated by repeating the subterm flagged by |l [symbol] =|n−1 [symbol] a total number of p times.

One example method of implementing the above-described algorithm of Theorem 1 is illustrated in FIG. 1. FIG. 1 shows a flow diagram for an example method 100 for a quantum computer. At 110, method 100 comprises receiving a target matrix comprising only real eigenvalues. In some examples, the target matrix may be a diagonalizable matrix. Hermitian Hamiltonians are guaranteed to have real eigenvalues, while non-Hermitian Hamiltonians may comprise complex eigenvalues. In the disclosed examples, non-Hermitian Hamiltonians are required to have real eigenvalues for the Chebyshev case.

At 120, method 100 comprises presenting the target matrix as block encoding. The numerator and the denominator are straightforward to block encode on a quantum computer, but finding the inverse of the denominator is a technical challenge, necessitating the use of the linear system solver to invert the matrix. Once the inverse is found, Equation 18 can be realized when applied on the zero state in the register. The shift matrix acts on some arbitrary quantum state on the register to derive the superposition of Chebyshev polynomials.

Applying the generating function includes doing block encoding to the right-hand side of Equation 18, specifically the numerator. A matrix is generated that acts on the quantum state, effectively applying the matrix directly to the quantum state. The numerator has a known identity and can be implemented via the lower shift matrix. The denominator is more challenging to implement, as it is difficult to derive the inverse of the denominator, and very difficult to precompute.

At 130, method 100 comprises precomputing a polynomial approximation for a function to be applied to the target matrix. A quantum linear systems solver may be employed to calculate the inverse of the denominator as a subroutine in Equation 18. The quantum linear systems solver is a well-known algorithm for inverting matrices on a quantum computer. Given a linear system of equations where CX=B and a known block encoded form of C, the quantum linear systems solver can produce a quantum state encoding the solution X, where X is C inverse of B.

One input of the linear system solver is the estimated eigenstates. There are quantum states on the input. The overall quantum state is divided into two parts. One part contains the beta coefficients defining the target function to be implemented, and the other part defines the subject problem to be solved. The linear system solver requires block encoding of the numerator and the denominator to be applied to the state. It also requires the ability to generate the state of beta coefficients and the size state. The result of the linear system solver is Equation 16 up to an error epsilon. In Equation 16, this can be a shared history state based on the choice of generating function. Different choices of generating functions will yield different history states associated with different families of polynomials, and then those have their own set of applications. Once these history states are generated, the state within the right-hand part of the numerator can be extracted. This extraction may occur with a certain probability. The probability may be amplified with amplitude amplification, but at a cost.

At 140, method 100 comprises selecting coefficients for a generating function that match the precomputed polynomial approximation. In Equation 18, the left-hand side is typically complicated to solve and difficult to directly implement on a quantum computer. The right-hand side is a more succinct expression that can be efficiently implemented on a quantum computer. In other words, implementing a particular polynomial is difficult, but implementing its generating function is less technically complex.

Inverting the right-hand side of equation 18 yields the scroll position of these Chebyshev polynomials. The method proceeds by observing this shift matrix in Equation 19. The shift matrix moves a state from zero to 1, from 1 to 2, from 3 to 4, etc. If it were to be applied to the zero state, then it would map 0 to the state J. This iterates to associate the index J with the J^{th} Chebyshev polynomial in Equation 18.

Applying this generating function on a quantum computer comprises doing a block encoding of the right hand side of Equation 18. Through a computer science Oracle, there's a straightforward way to block encode this matrix on a quantum computer by making a matrix that acts on the quantum state by directly applying that matrix to the quantum state.

At 150, method 100 comprises generating a polynomial history state comprising a superposition of polynomials onto the block encoded target matrix by at least mapping the generating function to a quantum algorithm. Equation 16 comprises two components. First, superpositions of Chebyshev polynomials are prepared, and then polynomials are paired with corresponding coefficients. In this example, the Chebyshev polynomials are denoted by T and the coefficients are denoted by β. Different β's can be chosen depending on the specific applications.

In such a superposition, there is an index J. Attached to the index J will be the J^{th} Chebyshev polynomial of the target matrix applied on an input state. Preparing this state with the appropriate coefficients on each of the J components yields a method to design an arbitrary approximation. Thus, coefficients can be selected to match the precomputed Chebyshev approximation to the chosen function.

The right-hand side of Equation 18 is derived from Equation 10, the generating function for Chebyshev polynomials. In other words, the generating function of Equation 10 may be mapped to a quantum algorithm for deriving the Chebyshev history state, e.g., the right-hand side of Equation 18. To do this, the parameter z is replaced by the lower shift matrix in Equation 19, and the parameter x is replaced by the matrix that the function transformation is to be applied on. Any suitable generating function can be used that matches with the selected family of polynomials. The right-hand side of equation 18 is then converted to a quantum algorithm known as the linear system solver.

Looking at Equation 8, a sum of Chebyshev polynomials is expressed over different degrees. The parameter X is the argument which goes into the Chebyshev polynomial, and a parameter Z, whose exponents selects the degree of transmission of the polynomial. The sum is equal to the generating function on the right-hand side of the equation. With the generating function, for any index J (e.g., Z^{j} in the power series), the J^{th} Chebyshev polynomial is generated.

Once that is done, Equation 18 may be applied on states (e.g., the zero state) stored in the register, the shift matrix may act on an arbitrary quantum state on the register, and the A matrix is block encoded, enabling the superposition of Chebyshev polynomials.

The application of the Chebyshev generating function to the initial state can be formulated as solving a system of linear equations with coefficient matrix

$$2 ( I ⊗ I + {L}^{2} ⊗ I - 2 L ⊗ \frac{A}{{α}_{A}} )$$

and target vector

$$( I ⊗ I - {L}^{2} ⊗ I ) ( \frac{1}{‖ \tilde{β} ‖} {\sum }_{k = 0}^{n - 1} {\tilde{β}}_{k} \vert n - 1 - k 〉 \vert ψ 〉 ) ,$$

which can in turn be solved by quantum linear system algorithms. This process is shown in FIG. 2 in the flow diagram for a method 200 for generating a Chebyshev history state using a quantum computer. At 210, method 200 includes receiving a diagonalizable matrix A comprising only real eigenvalues. Diagonalizable matrix A may be received from a quantum computing oracle O_{A} as a first register indicating whether A is successfully applied.

At 220, method 200 comprises block encoding

$$I ⊗ I + {L}^{2} ⊗ I - 2 L ⊗ \frac{A}{{a}_{A}}$$

to generate a first component, where L is a n-by-n lower shift matrix and α_{A} is a normalization factor ≥21∥A∥.

$$\frac{A}{{α}_{A}}$$

is thus a coefficient matrix. At 230, method 200 comprises receiving, as input a set of coefficients β. Coefficients β may be received from a quantum computing oracle O_{β} as a second register indicating amounts of any shifting in A. At 240, method 200 includes receiving, as a second component, an initial state v. Initial state W may be received from a quantum computing oracle Oψ as a third register.

At 250, method 200 comprises reversing the set of coefficients β and applying I⊗I−L²⊗I to the initial state ψ to generate a third component, a target vector. At 260, method 200 includes applying a quantum linear system algorithm to the first, second, and third components to generate the Chebyshev history state as described herein. At 270, method 200 includes outputting the Chebyshev history state.

To produce an ϵ-approximate solution state |X [symbol] corresponding to the linear equations Cx=b, the fastest quantum linear system solver uses

$$𝒪 ( {κ}_{C} log ( \frac{1}{ϵ} ) )$$

queries to the block-encoding of C and the unitary preparing the normalized initial state |b [symbol] . The claimed complexity is established by bounding the condition number of a padded version of

$$2 ( I ⊗ I + {L}^{2} ⊗ I - 2 L ⊗ \frac{A}{{α}_{A}} ) ,$$

and so wing explicitly how the padded matrix can be block-encoded with a constant normalization factor using 1 query to the block-encoding of A/α_{A}.

The goal of methods 100 and 200 is to apply functions on the input matrix that cannot be directly implemented but that can be approximately implemented using a polynomial expansion. A polynomial approximation of that function can be generated by using a sum of Chebyshev polynomials. The Chebyshev polynomials are generated by a generating function that maps 1 to 1 to the quantum algorithm. If a different generating function is used, a different family of polynomials is yielded. Via the generating function, a superposition of the polynomials onto the target matrix is generated.

This method is similar to phase estimation in overall structure. However, prior techniques for generating a history state in phase estimation apply to Hermitian matrices. Such techniques do not work for non-Hermitian matrices. Herein, a generating function-based approach to preparing a Chebyshev history state is presented. For eigenvalue estimation, uniform coefficients may be applied. For eigenvalue transformation, different families of polynomials yield different approximation properties for different functions. For the present applications, coefficients are precomputed to be based coefficients for Chebyshev polynomials, as those are known to improve uniform error approximation (e.g., the error between the approximated function and the true function).

Once this history state is established, the QFT inverse can be applied using the same step as in regular phase estimation. That QFT inverse register can be measured, and that measurement will yield the target eigenvalue through classical post-processing.

Mapping a generating function to a quantum algorithm generalizes to other generating functions. So for different families of polynomials, the right-hand side is replaced with a suitable function and is then the converted to the quantum algorithm. To perform the mapping: X goes to the matrix, Z goes to the lower shift matrix and then Equation 19 results from mapping this matrix followed by inversion by a quantum algorithm known as the linear system solver.

Complexity of these calculations, such as eigenvalue estimation, may be related to the cost incurred to generate the Chebyshev history state. This is given in Equation 17. Previously, a full history state was generated for non-Hermitian Hamiltonians, based on the heavy machinery of quantum differential equation solvers. This may achieve similar results to implementing Equation 17, but with additional log factors in cost. The complexity herein may achieve the best possible result.

Equation 20 relates to how the concept of making the Chebyshev history state to approximate arbitrary functions can be generalized. Applying Equation 18 to the zero state in the L register will yield a uniform history state. However, it is not necessary to start with the zero state—an arbitrary state can be selected if the coefficients of this state have a direct correspondence to the function desired to be approximated. Using Equation 20, the state with coefficients of βₖ is applied to the L register. The βₖ values become the coefficients of the Chebyshev polynomials in the resulting superposition. The index state J is then removed, as the function approximation is a sum of Chebyshev polynomials.

Equation 12 details approximating a function with a Chebyshev expansion. A function ƒ(x) can be expanded into a basis of polynomials Tⱼ, which will all have an associated coefficient βⱼ that define a target approximation. Equation 14 informs what \tilde{β}ⱼ is. Chebyshev polynomials provide a benefit in that even if the sum is truncated to a finite order, the approximation to the function remains viable.

Equation 20 applies this principle to the reversal of the initial state. If a state is designed that has coefficients that are related to the target approximation, a superposition will be yielded after applying the linear system solver to the state in Equation 18, thus generating arbitrary function approximations. By selecting the correct coefficients, a superposition of Chebyshev polynomials can be generated, for example.

To complete the function approximation, the polynomials need to be collected back together. Given a superposition of these Chebyshev polynomials, the index state J is associated with the J^{th} Chebyshev polynomial. This index state J can be deleted, as the function approximation is a sum of Chebyshev polynomials, so there's no notion of having an index state J.

When Theorem 1 is specialized to different settings, different problems can be solved, such as eigenvalue estimations and eigenvalue transformations. If βⱼ is chosen to be uniform, those coefficients can be used for eigenvalue estimation. Alternatively, if the coefficients are chosen to be Chebyshev coefficients, the Chebyshev polynomial transformation can be implemented.

Post-processing may include amplitude amplification. Given a quantum state, and a portion of that quantum state desired to advance, that portion may be specifically amplified. This is shown for example in Equation 16, where the second part can be specifically amplified. This amplification comes with an associated cost, depending on the size of the second portion. If the second portion starts small, the cost in amplifying it is large. If the second portion starts reasonably large, the effort to amplify it is reduced.

In some examples, methods 100, and 200 are performed exclusively on a quantum computer. A classical computer may be used to classically compute some data in advance, for example, using this data to generate the set of coefficients βⱼ.

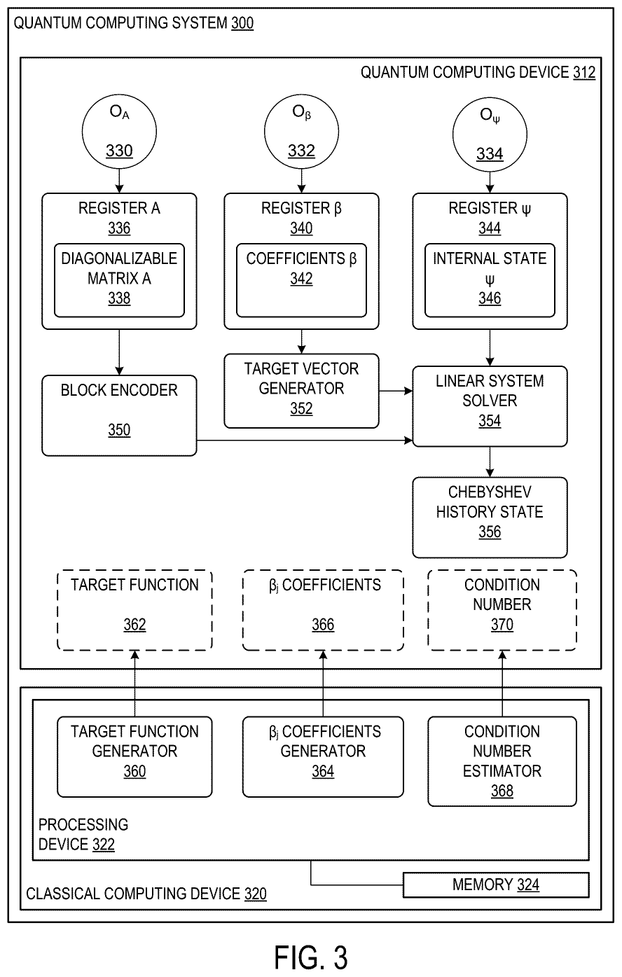

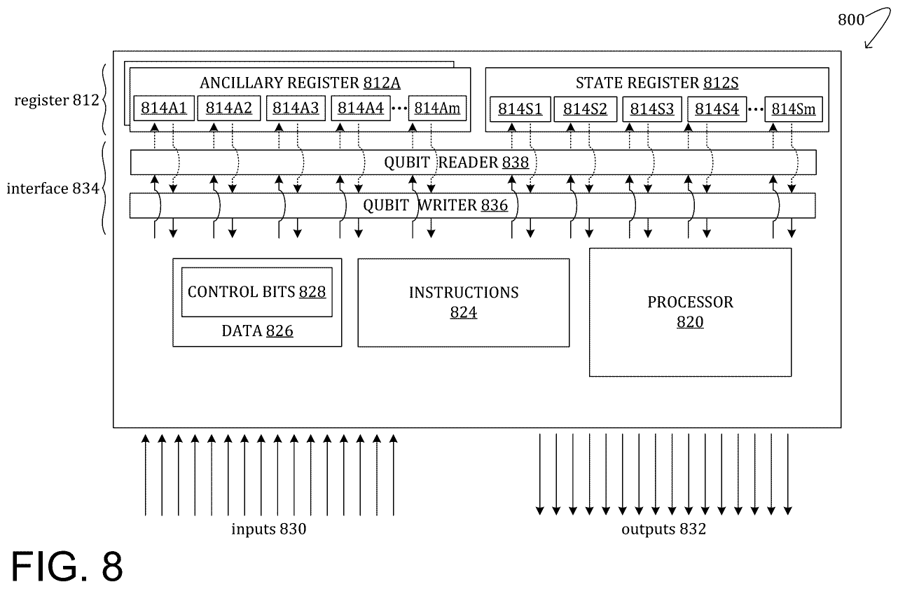

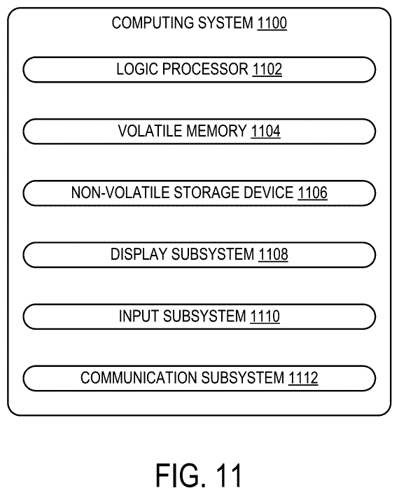

FIG. 3 schematically shows a quantum computing system 300 at which a Chebyshev history state is computed according to methods 100 and/or 200. As used herein, the term “quantum computing system” refers to computing systems comprising a quantum computing device, such as quantum computing device 312. In some examples, a quantum computing system further comprises a classical computing device. As such, the processing circuitry for a quantum computing system may comprise quantum computing hardware and may optionally include classical computing hardware. For example, classical computing hardware may perform step 130 of method 100 and may additionally or alternatively generate a β register as received at a quantum computing device in step 230 of method 200. Quantum computing system 300 depicted in FIG. 3 includes a quantum computing device 312 that is configured to communicate with a classical computing device 320. The classical computing device 320 includes one or more processing devices 322 and memory 324. Additional aspects of example quantum computing devices are described herein and with regard to FIGS. 8-10. Additional aspects of example classical computing devices are described herein and with regard to FIG. 11.

Quantum computing device 312 comprises three Oracles—O_{A} 330, O_{β} 332, and Oψ 334. O_{A} 330 provides Register A 336, comprising diagonalizable matrix A 338. O_{β} 332 provides register β 340, comprising coefficients β 342. Oψ 334 provides register ψ 344, comprising internal state ψ 346. Block encoder 350 block encodes diagonalizable matrix A 338. Target vector generator 352 generates a target vector based on coefficients β 342. Linear system solver 354 is provided the outputs of block encoder 350 and target generator 352 as well as internal state ψ 346 and generates Chebyshev history state 356.

At classical computing device 320, a target function generator 360 is provided. The target function 362 to be approximated is provided, thus Equation 12 is executed on processing device 322. More fundamentally, different variations of this algorithm may incur different computational costs, and thus different variations of this algorithm may have different classical side components. At classical computing device 320, a βⱼ coefficients generator 364 is provided that may be employed to precompute βⱼ coefficients 366. However, there are also ways to perform this computation on a quantum computer, and there may be fewer gates used asymptotically. At classical computing device 320, a condition number estimator 368 is provided. In some examples, such as in Equation 17, the complexity depends on various parameters like the condition number. It can save resources to estimate condition numbers 370 before applying the quantum algorithm. Condition number estimator 368 may estimate an upper bound of the condition number. Knowledge of the upper bound of the condition number can guarantee that the quantum algorithm will work. Condition numbers 370 can thus be estimated before applying the quantum algorithm of linear system solver 354.

Once the polynomial history state is generated, it can be used as an input for solving problems. For example, the QFT inverse can be applied similarly as for regular phase estimation. The QFT inverse register can be measured and that measurement will be the eigenvalue encoded in a binary format. All prior techniques for performing the phase estimation case work only for Hermitian matrices. It was heretofore unknown how to create a full history state for non-Hermitian matrices.

Thus, the ability to generate the Chebyshev history state in turn allows for efficiently estimating and transforming the eigenvalues of non-normal matrices. In particular, the following QEVE algorithm may be used.

Theorem 2 (Quantum eigenvalue estimation). Let A be a diagonalizable matrix with only real eigenvalues, and A=SΛS⁻¹ be its eigenvalue decomposition with condition number κ_{S}=∥S∥∥S⁻¹∥. Let O_{A} be a block encoding of A/α_{A} for some normalization factor α_{A}≥2∥A∥. Suppose that oracle O_{ψ}|0 [symbol] =|ψ [symbol] prepares an initial state with distance ∥|ψ [symbol] −|ψ_{λ}∥= [symbol] (ϵ/α_{A}κ_{S}) from an eigenstate |λ_{λ} [symbol] with A|ψ_{λ} [symbol] =λ|ψ_{λ} [symbol] . Then, the eigenvalue λ can be estimate with accuracy ϵ and probability 1 −p using

$$𝒪 ( \frac{{α}_{A} {κ}_{S}}{ϵ} log ( \frac{1}{p} ) ) \qquad ( Eq . 23 )$$

queries to controlled-O_{A}, controlled-O_{ψ}, and their inverses.

Although optimal algorithms for the singular value estimation have long been known, the optimal estimation of eigenvalues of non-normal matrices has remained elusive. Conventional approaches for QEVE are based on a reduction to solving systems of linear differential equations. As existing quantum differential equation algorithms are not known to be optimal for non-normal matrices, these resulting eigenvalue estimation algorithms have a query complexity of

$$𝒪 ( \frac{{α}_{A} {κ}_{S}}{ϵ} polylog ( \frac{{α}_{A} {κ}_{S}}{ϵ p} ) )$$

and are thus also not optimal. In contrast, the systems and methods of the present disclosure achieve a query complexity of

$$𝒪 ( \frac{{α}_{A} {κ}_{S}}{ϵ} log ( \frac{1}{p} ) ) ,$$

recovering the optimal scaling of the quantum singular value estimation.

At a high-level, the present approach starts by generating the following specific Chebyshev history state using Theorem 1. FIG. 4 shows a flow diagram for an example method 400 of estimating eigenvalues. At 410, method 400 comprises preparing a Chebyshev history state for a function. Such preparation may be performed using methods 100 or 200, for example.

Corollary 1. Let A be a diagonalizable matrix with only real eigenvalues, and A=SΛS⁻¹ be its eigenvalue decomposition with condition number κ_{S}=∥S∥∥S⁻¹∥. Let O_{A} be a block encoding of A/α_{A} for some normalization factor α_{A}≥2∥A∥, and O_{ψ}|0 [symbol] =|ψ [symbol] be the oracle preparing the initial state. Then, the quantum state

$$\frac{{\sum }_{l = 0}^{n - 1} \vert l 〉 {\tilde{T}}_{l} ( \frac{A}{{α}_{A}} ) \vert ψ 〉}{‖ {\sum }_{l = 0}^{n - 1} \vert l 〉 {\tilde{T}}_{l} ( \frac{A}{{α}_{A}} ) \vert ψ 〉 ‖} \qquad ( Eq . 24 )$$

can be generated using

$$𝒪 ( {κ}_{S} n log ( \frac{1}{ϵ} ) ) \qquad ( Eq . 25 )$$

queries to controlled-O_{A}, controlled-O_{ψ}, and their inverses, where \tilde{T}ₗ(x) are the rescaled Chebyshev polynomials defined by Equations 9 and 11.

To prepare this state, Theorem 1 is used with p=0 and

$${\tilde{β}}_{k} = \{ \begin{matrix}1 , & k = n - 1 , \\ 0 , & k \neq n - 1 .\end{matrix} \qquad ( Eq . 26 )$$

Under the assumption that the initial state |ψ [symbol] is at most [symbol] 1/(nκ_{S}))-distance away from the eigenstate |ψ_{λ} [symbol] , the above state has an overlap >½ with

$$\frac{{\sum }_{i = 0}^{n - 1} \vert l 〉 {\tilde{T}}_{l} ( \frac{λ}{{α}_{A}} ) \vert {ψ}_{λ} 〉}{‖ {\sum }_{i = 0}^{n - 1} \vert l 〉 {\tilde{T}}_{l} ( \frac{λ}{{α}_{A}} ) \vert {ψ}_{λ} 〉 ‖} = \frac{{\sum }_{i = 0}^{n - 1} \vert l 〉 {\tilde{T}}_{l} ( \frac{λ}{{α}_{A}} ) \vert {ψ}_{λ} 〉}{‖ {\sum }_{i = 0}^{n - 1} \vert l 〉 {\tilde{T}}_{l} ( \frac{λ}{{α}_{A}} ) \vert {ψ}_{λ} 〉 ‖} . \qquad ( Eq . 27 )$$

This state in turn has an overlap of ω(1−1/n) with

$$\frac{{\sum }_{i = 0}^{n - 1} \vert l 〉 {T}_{l} ( \frac{λ}{{α}_{A}} ) \vert {ψ}_{λ} 〉}{‖ {\sum }_{i = 0}^{n - 1} \vert l 〉 {T}_{l} ( \frac{λ}{{α}_{A}} ) \vert {ψ}_{λ} 〉 ‖} . \qquad ( Eq . 28 )$$

Dropping the irrelevant product state |ψ_{λ} [symbol] , the following is obtained

$$\frac{1}{\sqrt{{β}_{λ}}} {\sum }_{l = 0}^{n - 1} {T}_{l} ( \frac{λ}{{α}_{A}} ) \vert l 〉 = \frac{1}{\sqrt{{β}_{ϕ}}} {\sum }_{l = 0}^{n - 1} cos ( 2 π l ϕ ) ) \vert l 〉 \qquad ( Eq . 29 )$$

where

$$ϕ = \frac{1}{2 π} arccos ( \frac{λ}{{α}_{A}} ) , {β}_{ϕ} = {\sum }_{l = 0}^{n - 1} {cos}^{2} ( 2 π l ϕ ) . \qquad ( Eq . 30 )$$

Here, cos(2πlϕ) are periodic trigonometric functions, so the phase angle ϕ should be extractable using the Fourier transform. To realize this intuition, a variant of quantum phase estimation for the Chebyshev history state is developed according to the present disclosure, which may be of independent interest. At 420, method 400 comprises applying an inverse quantum Fourier transform to the function and measuring an ancilla register.

Lemma 1 (Chebyshev history state quantum phase estimation). Let

$$\frac{1}{\sqrt{{β}_{ϕ}}} {\sum }_{l = 0}^{n - 1} cos ( 2 π l ϕ ) \vert l 〉$$

be a Chebyshev history state with

$$ϕ ∈ [ \frac{1}{6} , \frac{1}{3} ]$$

and a corresponding normalization factor β_{ϕ}. There exists a quantum algorithm that outputs a value l∈{0, . . . , n−1} with constant probability >½ such that

$$\vert {mod}_{1} ( \frac{l}{n} \pm ϕ ) \vert = 𝒪 ( \frac{1}{n} ) . \qquad ( Eq . 31 )$$

Here,

$${mod}_{1} ( x ) = frac ( x + \frac{1}{2} ) - \frac{1}{2} ∈ [ - \frac{1}{2} , \frac{1}{2} ) \qquad ( Eq . 32 )$$

and frac(y) is the fractional part of y.

At 430, method 400 comprises using the ancilla register measurement to compute an initial estimate of an eigenvalue. For example,

$${α}_{A} cos ( 2 π \frac{l}{n} )$$

can be used to estimate λ, and can achieve an accuracy ϵ by setting n= [symbol] (α_{A}/ϵ). This fails with a constant probability <½.

At 440, method 400 comprises determining whether the number of initial estimates has reached a target repetition number. If the number of samples has not reached the target number an additional Chebyshev history state may be prepared. At 450, method 400 comprises computing a median of all initial estimates responsive to the number of samples increasing to a target repetition number. By repeating [symbol] (1/p) times and taking the median, the failure probability can be exponentially suppressed to below p. At 460, method 400 comprises outputting the median as the estimated eigenvalue.

Equation 21 gives the performance for method 400. Method 400 exhibits better performance metrics than prior art solutions for the same problem. Theorem 3 and FIG. 5 describe the general case where the βs are chosen according to the corresponding function approximation.

Besides the eigenvalue estimation, the availability of the Chebyshev history state also allows the application of polynomial functions to the eigenvalues of non-normal matrices. FIG. 5 shows a flow diagram for an example method 500 of quantum eigenvalue transformation.

Theorem 3 (Quantum eigenvalue transformation). Let A be a diagonalizable matrix with only real eigenvalues, and A=SΛS⁻¹ be its eigenvalue decomposition with condition number κ_{S}=∥S∥|S⁻¹∥. Let O_{A} be a block encoding of A/α_{A} for some normalization factor α_{A}≥2∥A∥, and O_{ψ}|0 [symbol] =|ψ [symbol] be the oracle preparing the initial state. Given a function ƒ: [−1,1]→ [symbol] with Chebyshev expansion ƒ(x)=Σⱼ₌₀^{∞}βⱼTⱼ(x), the quantum state

$$\frac{{\sum }_{k = 0}^{n - 1} {β}_{k} {T}_{k} ( \frac{A}{{α}_{A}} ) \vert ψ 〉}{‖ {\sum }_{k = 0}^{n - 1} {β}_{k} {T}_{k} ( \frac{A}{{α}_{A}} ) \vert ψ 〉 ‖} \qquad ( Eq . 33 )$$

can be prepared with accuracy E using

$$𝒪 ( \frac{{max}_{l} ‖ {\sum }_{k = l}^{n - 1} {β}_{k} {T}_{k - l} ( \frac{A}{{α}_{A}} ) \vert ψ 〉 ‖}{‖ f ( \frac{A}{{α}_{A}} ) \vert ψ 〉 ‖} {κ}_{S} n log \\ ( \frac{{max}_{l} ‖ {\sum }_{k = l}^{n - 1} {β}_{k} {T}_{k - l} ( \frac{A}{{α}_{A}} ) \vert ψ 〉 ‖}{‖ f ( \frac{A}{{α}_{A}} ) \vert ψ 〉 ‖ ϵ} ) ) \qquad ( Eq . 34 )$$

queries to controlled-O_{A}, controlled-O_{ψ}, and their inverses, where Tₖ(x) are the Chebyshev polynomials defined by Equation 9.

At 510, method 500 includes receiving a function having a Chebyshev expansion. At 520, method 500 includes receiving a Chebyshev history state for the function. The beta coefficients for the Chebyshev history state may be selected according to the Chebyshev expansion for the function. For example, the Chebyshev history state may be prepared as in Theorem 1 with p=n. At 530, method 500 includes performing amplitude amplification on the function based on the Chebyshev history state. At 540, method 500 includes repeating the amplitude amplification for a number of rounds based on a ratio of a shifted partial sum and a desired state. The number of amplitude amplification steps is determined by the ratio of the shifted partial sum

$${max}_{l} ‖ {\sum }_{k = l}^{n - 1} {β}_{k} {T}_{k - l} ( \frac{A}{{α}_{A}} ) \vert ψ 〉 ‖$$

and the desired state

$$‖ f ( \frac{A}{{α}_{A}} ) \vert ψ 〉 ‖ .$$

At 550, method 500 includes outputting the eigenvalue transformation based on the repeated amplitude amplification.

In the worst case, the QEVT algorithm has the query complexity

$$𝒪 ( \frac{{‖ f ‖}_{∞}}{{inf}_{x} \vert f ( x ) \vert} {κ}_{S} n log n log ( \frac{{‖ f ‖}_{∞}}{{inf}_{x} \vert f ( x ) \vert ϵ} ) ) . \qquad ( Eq . 35 )$$

However, it is shown that the present algorithm has a much better performance on average. In particular, this implies a quantum algorithm for solving systems of linear differential equations with strictly linear scaling in time on an average input, which is discussed in detail further herein and with regard to FIG. 6.

Additionally, according to the present systems and methods, an oracle O_{\tilde{β}} is implemented that prepares the Chebyshev coefficients:

$${0}_{\tilde{β}} \vert 0 〉 = \frac{1}{‖ \tilde{β} ‖} {\sum }_{k = 0}^{n - 1} {\tilde{β}}_{k} \vert k 〉 \qquad ( Eq . 36 )$$

This state can be prepared using standard circuits with gate complexity Θ(n). However, an improved circuit implementation is developed with gate complexity ˜log n∥ƒ∥_{∞}/∥ƒ∥₂ ignoring polylogarithmic factors, which may be of independent interest.

In one example, the function approximation can be selected to be the complex exponential function. Herein, these success probabilities and associated scaling are analyzed, yielding the expected complexity for the two, which is also better than previous results.

Consider the first-order linear differential equations

$$\frac{d x ( t )}{d t} = \tilde{A} x ( t ) , \qquad ( Eq . 37 )$$

whose formal solution is given by

$$x ( t ) = {e}^{t \tilde{A}} x ( 0 ) . \qquad ( Eq . 38 )$$

FIG. 6 shows a flow chart for an example method 600 for a linear-time quantum differential equation algorithm. At 610, method 600 includes receiving a matrix Ã, where Ã is a diagonalizable matrix with only imaginary eigenvalues. At 620, method 600 includes receiving a normalization factor α_{A}. At 630, method 600 includes block encoding Ã/α_{A}. At 640, method 600 includes generating a matrix iÃ/α_{A} based on the block encoding of Ã/α_{A}. At 650, method 600 includes implementing a function on iÃ/α_{A} using quantum eigenvalue transformation based on a Chebyshev history state for the function. For example, the function may be the complex exponential.

When Ã is diagonalizable with purely imaginary eigenvalues, QEVT can be used to implement the function ƒ(x)=e^{-iα}^{_{A}}^{tx} on the matrix iÃ/α_{A}, which can be easily obtained from a block encoding of Ã/α_{A}. An equivalent version of this result for A=iÃ can be expressed as follows:

Theorem 4 (Linear-time quantum differential equation solver). Let A be a diagonalizable matrix with only real eigenvalues, and A=SΛS⁻¹ be its eigenvalue decomposition with condition number κ_{S}=∥S∥∥S⁻¹∥. Let O_{A} be a block encoding of A/α_{A} for some normalization factor α_{A}≥2∥A∥, and O_{ψ}|0 [symbol] =|ψ [symbol] be the oracle preparing the initial state. Given an evolution time t, the quantum state

$$\frac{{e}^{- itA} \vert ψ 〉}{‖ {e}^{- itA} \vert ψ 〉 ‖} \qquad ( Eq . 39 )$$

can be prepared with accuracy ϵ using

$$𝒪 ( \sqrt{{max}_{l} {‖ {q}_{l} ‖}_{∞}} {κ}_{S}^{2} ( {α}_{A} t + log ( \frac{{κ}_{S}}{ϵ} ) ) log ( \frac{{max}_{l} {‖ {q}_{l} ‖}_{∞} {κ}_{S}}{ϵ} ) ) \qquad ( Eq . 40 )$$

queries to controlled-O_{A}, controlled-O_{ψ}, and their inverses. Here,

$${q}_{l} ( {x}_{l} ) = {\int }_{- 1}^{1} d {x}_{1} … {\int }_{- 1}^{1} d {x}_{l - 1} {\int }_{- 1}^{1} d {x}_{l + 1} … {\int }_{- 1}^{1} d {x}_{N} q ( {x}_{1} , … , {x}_{l - 1} , {x}_{l} , {x}_{l + 1} , … , {x}_{N} ) \qquad ( Eq . 41 )$$

is the marginal density function for the lth eigenvalue of A/α_{A}.

As a simple illustration, if eigenvalues of the input matrix A are uniformly distributed, eigenvalues of A/α_{A} are uniformly distributed as well, so ∥qₗ∥_{∞}= [symbol] (1) is constant. However, the present analysis can handle more general distributions of eigenvalues, as long as they are absolutely continuous with respect to the Lebesgue measure.

In comparison, the best previous query complexity scales like

$$𝒪 ( {κ}_{S}^{2} {α}_{A} tpoly log ( \frac{{κ}_{S} {α}_{A} t}{ϵ} ) ) . \qquad ( Eq . 42 )$$

Note that the complexity expressed here is different from the original result, which contains a factor of

$$\frac{{max}_{0 \leq τ \leq t} ‖ {e}^{- i τ A} \vert ψ 〉 ‖}{‖ {e}^{- itA} \vert ψ 〉 ‖} \qquad ( Eq . 43 )$$

This factor arises in a similar way as (although is incomparable to) the shifted Chebyshev partial sums in Theorem 1 and Theorem 3. However, note that this factor is still time dependent. To understand the actual time scaling, it is necessary to further upper bound that by the condition number as

$$\frac{{max}_{0 \leq τ \leq t} ‖ {e}^{- i τ A} \vert ψ 〉 ‖}{‖ {e}^{- itA} \vert ψ 〉 ‖} \leq {κ}_{S} \qquad ( Eq . 44 )$$

resulting in the query complexity as above.

Many recent results have examined the use of randomness in improving quantum simulation algorithms. However, most of these results have focused on the improvement of the product-formula algorithm and its variants. The present disclosure demonstrates that randomness can also be useful for speeding up more advanced quantum algorithms, which have applications to solving the quantum simulation problem and beyond.

FIG. 7. shows a flow chart for an example method 700 for generating a ground state. The coefficients of these generating functions are selected so that the polynomials will approximate the desired function. This use case may be applied to computational chemistry problems, among others, relative to advances in ground state preparation.

At 710, method 700 includes choosing coefficients of a generating function based on a desired polynomial function. At 720, method 700 includes generating a polynomial history state using the generating function. For example, the polynomial history state may be generated based on methods 100 and/or 200. At 730, method 700 includes receiving a diagonalizable matrix having only real eigenvalues. At 740, method 700 includes block encoding the diagonalizable matrix based on a normalization factor. At 750, method 700 includes preparing a series of quantum states based on the eigenvalues of the diagonalizable matrix and corresponding eigenstates. At 760, method 700 includes outputting a ground state based on the series of quantum states.

For example, let A be a diagonalizable matrix with only real eigenvalues, i.e., A=SΛS⁻¹ where Λ is a real diagonal matrix. Suppose that λ₀ is the smallest non-degenerate eigenvalue of A with eigenstate |ψ₀ [symbol] . A goal of the present disclosure is to approximately prepare a quantum state close to the ground state |ψ₀ [symbol] . This can be achieved with the following algorithm.

Theorem 5 (Ground state preparation). Let A be a diagonalizable matrix with only real eigenvalues, and A=SΛS⁻¹ be its eigenvalue decomposition with condition number κ_{S}=∥S∥∥S⁻¹∥. Suppose that Δₗ are the eigenvalues of A ordered nondecreasingly and |ψₗ [symbol] are the corresponding eigenstates. Assume that there are known numbers μ and Δ>0 such that

$${λ}_{0} \leq μ - \frac{Δ}{2} < μ < μ + \frac{Δ}{2} \leq {λ}_{1} . \qquad ( Eq . 45 )$$

Let O_{A} be a block encoding of A/α_{A} for some normalization factor α_{A}≥2∥A∥, and O_{ψ}|0=|ψ [symbol] be the oracle preparing the initial state

$$\vert ψ 〉 = {c}_{0} \vert {ψ}_{0} 〉 + {\sum }_{l = 1}^{N - 1} {c}_{l} \vert {ψ}_{l} 〉 . \qquad ( Eq . 46 )$$

then a quantum state |\tilde{ψ} [symbol] can be prepared such that

$$\vert 〈 {ψ}_{0} \vert \tilde{ψ} 〉 \vert \geq 1 - ϵ \qquad ( Eq . 47 )$$

using

$$𝒪 ( \frac{\sqrt{{max}_{l} {‖ {q}_{l} ‖}_{∞}} {α}_{A} {κ}_{S}^{2}}{\vert {c}_{0} \vert Δ} {log}^{2} ( \frac{{max}_{l} {‖ {q}_{l} ‖}_{∞} {κ}_{S}}{\vert {c}_{0} \vert ϵ} ) ) \qquad ( Eq . 48 )$$

queries to controlled-O_{A}, controlled-O_{ψ}, and their inverses. Here,

$${q}_{l} ( {x}_{l} ) = {\int }_{- 1}^{1} d {x}_{1} ... {\int }_{- 1}^{1} d {x}_{l - 1} {\int }_{- 1}^{1} d {x}_{l + 1} ... {\int }_{- 1}^{1} d {x}_{N} q ( {x}_{1} , ... , {x}_{l - 1} , {x}_{l} , {x}_{l + 1} , ... , {x}_{N} ) \qquad ( Eq . 49 )$$

is the marginal density function for the lth eigenvalue of A/α_{A}.

When the input matrix A is Hermitian, the result recovers the nearly optimal ground state preparation result of up to a logarithmic factor. However, the present algorithm is obviously more general in that it applies to non-normal matrices with real eigenvalues whose ground state is well defined.

At a high level, the algorithm of the present disclosure works by applying a polynomial p of degree

$$n = 𝒪 ( \frac{1}{\tilde{δ}} log ( \frac{1}{\tilde{ϵ}} ) )$$

such that

$$\{ \begin{matrix}\vert p ( x ) \vert \leq 1 , & ∀ x ∈ [ - 1 , 1 ] , \\ \vert p ( x ) - \frac{1 - Sign ( x )}{2} \vert \leq \tilde{ϵ} , & ∀ x ∈ [ - 1 , - \tilde{δ} ] ⋃ [ \tilde{δ} , 1 ] .\end{matrix} \qquad ( Eq . 50 )$$

Choosing

$$\tilde{δ} = Θ ( \frac{Δ}{{α}_{A}} ) ,$$

p is applied to the matrix

$$\frac{A - μ I}{{α}_{A} + \vert μ \vert}$$

whose eigenvalues satisfy

$$\frac{{λ}_{0} - μ}{{α}_{A} + \vert μ \vert} \leq - \frac{Δ}{3 {α}_{A}} < 0 < \frac{Δ}{3 {α}_{A}} \leq \frac{{λ}_{1} - μ}{{α}_{A} + \vert μ \vert} . \qquad ( Eq . 51 )$$

obtaining an approximate (non-orthogonal) projector

$$‖ p ( \frac{A - μ I}{{α}_{A} + \vert μ \vert} ) - S \vert 0 〉 {〈 0 \vert S}^{- 1} ‖ \leq \frac{{κ}_{S} \tilde{ϵ}}{2} . \qquad ( Eq . 52 )$$

This implies

$$\frac{\vert 〈 {ψ}_{0} \vert p ( \frac{A - μ I}{{α}_{A} + \vert μ \vert} ) \vert ψ 〉 \vert}{‖ p ( \frac{A - μ I}{{α}_{A} + \vert μ \vert} ) \vert ψ 〉 ‖} \geq 1 - \frac{{κ}_{S} \tilde{ϵ}}{\vert {c}_{0} \vert} . \qquad ( Eq . 53 )$$

Thus to achieve a fidelity of at least 1-ϵ, the degree of the polynomial should scale like

$$n = 𝒪 ( \frac{{α}_{A}}{Δ} log ( \frac{{κ}_{S}}{\vert {c}_{0} \vert ϵ} ) ) . \qquad ( Eq . 54 )$$

The following principles follow from Theorem 3.

In general, these transformations are performed on non-Hermitian matrices that are diagonalizable. However, many families of non-Hermitian matrices are not diagonalizable. The present disclosure describes certain generalizations and non-diagonalizable cases that can be handled. The non-diagonalizable matrices may be approximated with the closest diagonalizable matrix. This may also apply to non-Hermitian cases that have real eigenvalues.

In a Hermitian matrix the conjugate transpose of the matrix is the same matrix. Most prior art focuses on Hermitian matrices and singular values of matrices in general. For example, prior algorithms exist to transform the singular values of rectangular matrices and other non-Hermitian matrices. The eigenvalues of non-Hermitian matrices are different from the singular values of the same matrix.

There are reasons to transform the singular values and the eigenvalues. These transformations will yield different results, so the singular value case is extremely well known. Any matrix has a singular value decomposition, including those that are non-normal. But for non-normal matrices, the eigenvalues of diagonalizable matrices are different from singular values.

The above methods are generally applicable to non-normal matrices that are diagonalizable. However, there are many families of non-normal matrices that are not diagonalizable. In certain cases, the disclosed methods can be applied to such matrices by approximating the non-diagonalizable matrices with the closest diagonalizable matrix. It is well known in linear algebra that an arbitrary complex square matrix is similar to a direct sum of Jordan matrices of the form

$$J = [ \begin{matrix}λ & 1 & 0 & ⋯ & ⋯ & 0 \\ & λ & 1 & 0 & ⋯ & ⋮ \\ & & λ & 1 & ⋱ & ⋮ \\ & & & ⋱ & ⋱ & 0 \\ & & & & λ & 1 \\ & & & & & λ\end{matrix} ] . \qquad ( Eq . 55 )$$

When such a matrix is 1-by-1, it reduces to the scalar A on the diagonal, corresponding to an eigenvalue λ of the original matrix with a linearly independent eigenstate. In general, such a matrix can be m-by-m, corresponding to a generalized eigenspace of dimension m. The eigenvalue λ has multiplicity m but the generalized eigenspace contains only 1 linearly independent eigenstate.

A function can be applied to a square matrix. If the matrix is diagonalizable, then one can simply diagonalize the matrix and apply the function to each of its eigenvalues. For an arbitrary matrix, functions of matrices can be defined using the Taylor series. Specifically, suppose ƒ is a real-variable function analytic on an interval enclosing all eigenvalues of matrix A. Then, the Taylor expansion of ƒ around each eigenvalue λ can be written and the action of ƒ(A) can be defined by a direct substitution. Although there may be infinite terms in the Taylor expansion, only finite terms survive after the substitution. Concretely,

$$f ( J ) = [ \begin{matrix}f ( λ ) & {f}^{′ ( λ )} & \frac{{f}^{( 2 )} ( λ )}{2 !} & ⋯ & ⋯ & \frac{{f}^{( m - 1 )} ( λ )}{( m - 1 ) !} \\ & f ( λ ) & {f}^{′ ( λ )} & \frac{{f}^{( 2 )} ( λ )}{2 !} & ⋯ & ⋮ \\ & & f ( λ ) & {f}^{′ ( λ )} & ⋱ & ⋮ \\ & & & ⋱ & ⋱ & \frac{{f}^{( 2 )} ( λ )}{2 !} \\ & & & & f ( λ ) & {f}^{′ ( λ )} \\ & & & & & f ( λ )\end{matrix} ] . \qquad ( Eq . 56 )$$

In other words, for the definition to make sense, not only the function ƒ itself is needed, but also its higher derivatives; in fact, ƒ should be sufficiently smooth at λ to order m−1 if the largest λ-Jordan block has size m-by-m.

Although an arbitrary matrix A may not be diagonalizable, it can be arbitrarily approximated by a diagonal matrix. In fact, A can be arbitrarily approximated by matrices with distinct eigenvalues. A concrete error bound for approximating the Jordan matrix J defined above is now presented.

Lemma 2 (Denseness of diagonalizable matrices). Let J be the m-by-m Jordan matrix defined by Equation 55. For any δ>0, there exists a diagonal matrix Λ and an invertible matrix S, such that

$$\tilde{J} = S Λ {S}^{- 1} , \qquad ( Eq . 57 )$$

where

$$‖ λ I - Λ ‖ < δ , ‖ S ‖ , ‖ {S}^{- 1} ‖ \leq \frac{{m}^{m}}{{δ}^{m - 1}} . \qquad ( Eq . 58 )$$

When using this bound, m should be thought of as a constant (so that the target matrix is close to being diagonalizable). In particular, when m=1, ∥S∥=∥S⁻¹|=1, and there is no increase in the Jordan condition number. In general, the Jordan condition number increases by a factor of poly

$$( \frac{1}{δ} )$$

with the degree of the polynomial depending on the size of the largest Jordan block.

Now the goal is to translate the approximation of functions of Jordan matrices to that of diagonalizable matrices. Specifically

$$f ( J ) \approx f ( \tilde{J} ) \approx p ( \tilde{J} ) \approx p ( J ) \qquad ( Eq . 59 )$$

where p is some polynomial approximation of ƒ. The error of the second approximation can be bounded using existing bounds for diagonalizable matrices with the perturbed eigenvalues and modified Jordan condition number given above.

The first and third approximations are essentially perturbations of matrix functions. It is generally quite difficult to derive a tight bound due to the non-commutativity of matrices. In the following, two concrete cases are analyzed, which are most relevant to the differential equation application studied.

First, consider the exponential function

$$f ( z ) = {e}^{itz} , z ∈ ℝ . \qquad ( Eq . 60 )$$

This yields

$${e}^{itJ} - {e}^{it \tilde{J}} = {e}^{it \tilde{J}} ( {e}^{- it \tilde{J}} {e}^{itJ} - I ) = {\int }_{0}^{t} d τ {e}^{i ( t - τ ) \tilde{J}} ( iJ - i \tilde{J} ) {e}^{i τ J} . \qquad ( Eq . 61 )$$

Note that by Equation 56,

$${e}^{i τ J} = [ \begin{matrix}{e}^{i τ λ} & i τ {e}^{i τ λ} & … & \frac{{( i τ )}^{m - 1}}{( m - 1 ) !} {e}^{i τ λ} \\ & ⋱ & ⋱ & ⋮ \\ & & ⋱ & i τ {e}^{i τ λ} \\ & & & {e}^{i τλ}\end{matrix} ] . \qquad ( Eq . 62 )$$

### Therefore,

$$‖ {e}^{i τ J} ‖ \leq m {τ}^{m - 1} . \qquad ( Eq . 63 )$$

On the other hand, ∥e^{i(t-τ)\tilde{J}}∥ can be analyzed by diagonalizing \tilde{J} with the Jordan condition number bounded above. Specifically,

$$‖ {e}^{i ( t - τ ) \tilde{J}} ‖ \leq ‖ S ‖ ‖ {S}^{- 1} ‖ \leq \frac{{m}^{2 m}}{{δ}^{2 m - 2}} . \qquad ( Eq . 64 )$$

Combining these with the assumption that ∥J−\tilde{J}∥<δ, the desired bound for ∥e^{itj}−e^{it\tilde{J}}∥ is obtained.

Consider also the power function

$$f ( z ) = {z}^{k} , z ∈ ℝ , k ∈ {ℤ}_{\geq 1} . \qquad ( Eq . 65 )$$

This yields

$${J}^{k} - {\tilde{J}}^{k} = {\sum }_{j = 0}^{k - 1} {J}^{j} ( J - \tilde{J} ) {\tilde{J}}^{k - 1 - j} . \qquad ( Eq . 66 )$$

where

$$‖ {J}^{j} ‖ \leq {mj}^{m - 1} . \qquad ( Eq . 67 )$$

Similar to the exponential function, ∥J^{k-1-j}∥ can be bounded by diagonalizing \tilde{J} with the modified Jordan condition number. Combining these with the assumption that ∥J−\tilde{J}∥<δ, the desired bound can be obtained. Note that this can be generalized to a Taylor series with absolutely converging coefficients.

Examples are herein provided for the more general generating functions that can be implemented. For example, the presently disclosed QEVE algorithm can be extended to estimate extremal eigenvalues (i.e., the largest eigenvalues in absolute value) of a diagonalizable matrix by implementing a geometric series; the generalization of QEVT is similar. These extremal eigenvalues largely determine the behavior of matrix power iteration and its various variants.

Specifically, let |ψ [symbol] be an eigenstate of A with eigenvalue λₘₐₓe^{iθ}, i.e., A|ψ [symbol] =λₘₐₓe^{iθ}|ψ [symbol] . Suppose that λₘₐₓ>0 is the largest absolute value of eigenvalues of A, and its value is known a priori. The goal is to estimate the phase angle θ. This can be achieved using the series

$${\sum }_{j = 0}^{n - 1} {L}^{j} ⊗ \frac{{A}^{j}}{{λ}_{max}^{j}} = {\sum }_{j = 0}^{∞} {L}^{j} ⊗ \frac{{A}^{j}}{{λ}_{max}^{j}} = \frac{I}{I - \frac{L ⊗ A}{{λ}_{max}}} . \qquad ( Eq . 68 )$$

To implement this, let A be block encoded with normalization factor α_{A}>0, i.e.,

$$( 〈 0 \vert ⊗ I ) V ( \vert 0 〉 ⊗ I ) = \frac{A}{{α}_{A}} \qquad ( Eq . 69 )$$

for some unitary V. Then, using the fact that L can be block encoded with normalization factor 1, taking the tensor product yields

$$( 〈 0 \vert ⊗ I ) W ( \vert 0 〉 ⊗ I ) = \frac{L ⊗ A}{{α}_{A}} \qquad ( Eq . 70 )$$

for some unitary W. This means the state preparation

$$PRE \vert 0 〉 = \frac{\sqrt{\frac{{α}_{A}}{{λ}_{max}}} \vert 0 〉 + \vert 1 〉}{\sqrt{\frac{{α}_{A}}{{λ}_{max}} + 1}} \qquad ( Eq . 71 )$$

and the operator selection

$$SEL = \vert 0 〉 〈 0 \vert ⊗ ( - W ) + \vert 1 〉 〈 1 \vert ⊗ I \qquad ( Eq . 72 )$$

will block encode

$$( 〈 0 \vert PRE {P}^{†} ⊗ I ) SEL ( PREP \vert 0 〉 ⊗ I ) = \frac{I - \frac{L ⊗ A}{{λ}_{max}}}{\frac{{α}_{A}}{{λ}_{max}} + 1} . \qquad ( Eq . 73 )$$

Now, the quantum linear system algorithm is invoked to prepare the state

$$\frac{\frac{\frac{I}{I - \frac{L ⊗ A}{{λ}_{max}}}}{\frac{{α}_{A}}{{λ}_{max}} + 1} \vert 0 〉 \vert ψ 〉}{‖ \frac{\frac{I}{I - \frac{L ⊗ A}{{λ}_{max}}}}{\frac{{α}_{A}}{{λ}_{max}} + 1} \vert 0 〉 \vert ψ 〉 ‖} = \frac{\frac{I}{I - \frac{L ⊗ A}{{λ}_{max}}} \vert 0 〉 \vert ψ 〉}{‖ \frac{I}{I - \frac{L ⊗ A}{{λ}_{max}}} \vert 0 〉 \vert ψ 〉 ‖} = \frac{{\sum }_{j = 0}^{n - 1} {L}^{j} ⊗ \frac{{A}^{j}}{{λ}_{max}^{j}} \vert 0 〉 \vert ψ 〉}{‖ {\sum }_{j = 0}^{n - 1} {L}^{j} ⊗ \frac{{A}^{j}}{{λ}_{max}^{j}} \vert 0 〉 \vert ψ 〉 ‖} = \frac{1}{\sqrt{n}} {\sum }_{j = 0}^{n - 1} {e}^{ij θ} \vert j 〉 \vert ψ 〉 . \qquad ( Eq . 74 )$$

The phase angle θ can now be estimated using quantum phase estimation.

An example is provided of solving differential equations in linear time as described herein. Previously, the solution was provided for a differential equation that is homogeneous, the following is a slightly more general application.

Next, an explanation is provided of the adaptation of the above described techniques to solve the inhomogenous differential equation

$$\frac{d x ( t )}{d t} = \tilde{A} x ( t ) + b . \qquad ( Eq . 75 )$$

This has the exact solution

$$x ( t ) = {e}^{t \tilde{A}} x ( 0 ) + \frac{{e}^{t \tilde{A}} - I}{\tilde{A}} b . \qquad ( Eq . 76 )$$

With the substitution A=iÃ, the presently disclosed approach is to consider the Chebyshev expansion of both

$$f ( x ) = {e}^{- i {α}_{A} tx} \approx {\sum }_{j = 0}^{n - 1} {β}_{j} {T}_{j} ( x ) \qquad ( Eq . 77 )$$

$$and$$

$$g ( x ) = \frac{{e}^{- i {α}_{A} tx} - I}{- i {α}_{A} x} \approx {\sum }_{j = 0}^{n - 1} {γ}_{j} {T}_{j} ( x ) . \qquad ( Eq . 78 )$$

Note that ƒ and g can be extended to complex variable functions that are analytic on the entire complex plane, and their truncation error has a similar scaling. Then, the Chebyshev generating function is used as before to generate a state proportional to

$$\vert 0 〉 {\sum }_{j = 0}^{n - 1} {β}_{j} {T}_{j} ( \frac{A}{{α}_{A}} ) \vert {x}_{0} 〉 + \vert 1 〉 {\sum }_{j = 0}^{n - 1} {γ}_{j} {T}_{j} ( \frac{A}{{α}_{A}} ) \vert b 〉 . \qquad ( Eq . 79 )$$

Finally, amplitude amplification is performed in the first register.

In some embodiments, the methods and processes described herein may be tied to a computing system of one or more computing devices. In particular, such methods and processes may be implemented as a computer-application program or service, an application-programming interface (API), a library, and/or other computer-program product.

Some aspects of an example quantum-computer architecture will first be described. FIG. 8 shows aspects of an example quantum computer 800 configured to execute quantum-logic operations (vide infra). Quantum computer 800 may be an embodiment of quantum computing device 312 described herein and with reference to FIG. 3. Whereas conventional computer memory holds digital data in an array of bits and enacts bit-wise logic operations, a quantum computer holds data in an array of qubits and operates quantum-mechanically on the qubits in order to implement the desired logic. Accordingly, quantum computer 800 of FIG. 8 includes a set of qubit registers 812—e.g., state register 812S and auxiliary register 812A. Each qubit register includes a series of qubits 814. The number of qubits in a qubit register is not particularly limited but may be determined based on the complexity of the quantum logic to be enacted by the quantum computer.

Qubits 814 of qubit register 812 may take various forms, depending on the desired architecture of quantum computer 800. Each qubit may comprise: a superconducting Josephson junction, a trapped ion, a trapped atom coupled to a high-finesse cavity, an atom or molecule confined within a fullerene, an ion or neutral dopant atom confined within a host lattice, a quantum dot exhibiting discrete spatial- or spin-electronic states, electron holes in semiconductor junctions entrained via an electrostatic trap, a coupled quantum-wire pair, an atomic nucleus addressable by magnetic resonance, a free electron in helium, a molecular magnet, or a metal-like carbon nanosphere, as non-limiting examples. A qubit may be implemented in the plural processing states corresponding to different modes of light propagation through linear optical elements (e.g., mirrors, beam splitters and phase shifters), as well as in states accumulated within a Bose-Einstein condensate. More generally, each qubit 814 may comprise any particle or system of particles that can exist in two or more discrete quantum states that can be measured and manipulated experimentally.

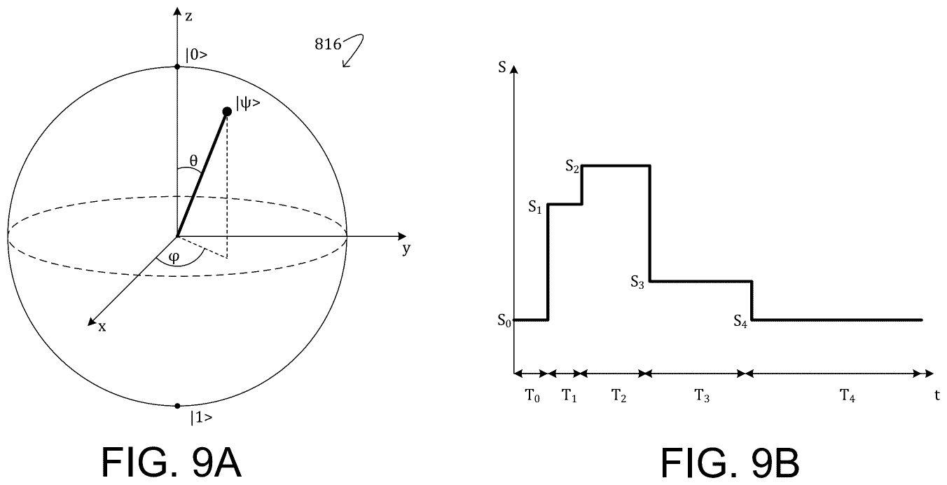

FIG. 9A is an illustration of a Bloch sphere 816, which provides a graphical description of some quantum mechanical aspects of an individual qubit 814. In this description, the north and south poles of the Bloch sphere correspond to the standard basis vectors |0 [symbol] and |1 [symbol] , respectively—up and down spin states, for example, of an electron or other fermion. The set of points on the surface of the Bloch sphere comprise all possible pure states |ψ [symbol] of the qubit, while the interior points correspond to all possible mixed states. A mixed state of a given qubit may result from decoherence, which may occur because of undesirable coupling to external degrees of freedom.

Returning now to FIG. 8, quantum computer 800 includes a controller 818. The controller may include at least one processor 820 and associated computer memory 822. Processor 820 may be coupled operatively to peripheral componentry, such as network componentry, to enable the quantum computer to be operated remotely. Processor 820 may take the form of a central processing unit (CPU), a graphics processing unit (GPU), or the like. As such, controller 818 may comprise classical electronic componentry. The terms ‘classical’ and ‘non-quantum’ are applied herein to any component that can be modeled accurately without considering the quantum state of any individual particle therein. Classical electronic components include integrated, microlithographed transistors, resistors, and capacitors, for example. Computer memory 822 may be configured to hold program instructions 824 that cause processor 820 to execute any function or process of controller 818. The computer memory may also be configured to hold additional data 826. In some examples, data 826 may include a register of classical control bits 828 that influence the operation of the quantum computer during run time—e.g., to provide classical control input to one or more quantum-gate operations. In examples in which qubit register 812 is a low-temperature or cryogenic device, controller 818 may include control componentry operable at low or cryogenic temperatures—e.g., a field-programmable gate array (FPGA) operated at 77K. In such examples, the low-temperature control componentry may be coupled operatively to interface componentry operable at normal temperatures.

Controller 818 of quantum computer 800 is configured to receive a plurality of inputs 830 and to provide a plurality of outputs 832. The inputs and outputs may each comprise digital and/or analog lines. At least some of the inputs and outputs may be data lines through which data is provided to and/or extracted from the quantum computer. Other inputs may comprise control lines via which the operation of the quantum computer may be adjusted or otherwise controlled.

Controller 818 is operatively coupled to qubit registers 812 via quantum interface 834. The quantum interface is configured to exchange data (solid lines) bidirectionally with the controller. The quantum interface is further configured to exchange signal associated with the data (dashed lines) bidirectionally with the qubit registers. Depending on the physical implementation of qubits 814, such signal may include electrical, magnetic, and/or optical signal. Via signal conveyed through the quantum interface, the controller may interrogate and otherwise influence the quantum state held in any, some, or all of the qubit registers, as defined by the collective quantum state of the qubits therein. To that end, the quantum interface includes qubit writer 836 and qubit reader 838. The qubit writer is configured to output a signal to one or more qubits of a qubit register based on write-data received from the controller. The qubit reader is configured to sense a signal from one or more qubits of a qubit register and to output read-data to the controller based on the signal. The read-data received from the qubit reader may, in some examples, be an estimate of an observable to the measurement of the quantum state held in a qubit register. Taken together, controller 818 and interface 834 may be referred to as a ‘control system’.

In some examples, suitably configured signal from qubit writer 836 may interact physically with one or more qubits 814 of a qubit register 812, to trigger measurement of the quantum state held in the one or more qubits. Qubit reader 838 may then sense a resulting signal released by the one or more qubits pursuant to the measurement, and may furnish read-data corresponding to the resulting signal to controller 818. Stated another way, the qubit reader may be configured to output, based on the signal received, an estimate of one or more observables reflecting the quantum state of one or more qubits of a qubit register, and to furnish the estimate to controller 818. In one non-limiting example, the qubit writer may provide, based on data from the controller, an appropriate voltage pulse or pulse train to an electrode of one or more qubits, to initiate a measurement. In short order, the qubit reader may sense photon emission from the one or more qubits and may assert a corresponding digital voltage level on a quantum-interface line into the controller. Generally speaking, any measurement of a quantum-mechanical state is defined by the operator O corresponding to the observable to be measured; the result R of the measurement is guaranteed to be one of the allowed eigenvalues of O. In quantum computer 10, R is statistically related to the qubit-register state prior to the measurement, but is not uniquely determined by the qubit-register state.

Pursuant to appropriate input from controller 818, quantum interface 834 may be configured to implement one or more quantum-logic gates to operate on the quantum state held in a qubit register 812. The term ‘state vector’ refers herein to the quantum state held in the series of qubits 814S of state register 812S of quantum computer 800. Whereas the function of each type of logic gate of a classical computer system is described according to a corresponding truth table, the function of each type of quantum gate is described by a corresponding operator matrix. The operator matrix operates on (i.e., multiplies) the complex vector representing a qubit register state and effects a specified rotation of that vector in Hilbert space.

For example, the Hadamard gate H is defined by

$$H = \frac{1}{\sqrt{2}} [ \begin{matrix}1 & 1 \\ 1 & - 1\end{matrix} ] . \qquad ( 80 )$$

The H gate acts on a single qubit; it maps the basis state |0 [symbol] to (|0 [symbol] +|1 [symbol] )/\sqrt{2}, and maps |1 [symbol] to (|0 [symbol] −|1 [symbol] )/\sqrt{2}. Accordingly, the H gate creates a superposition of states that, when measured, have equal probability of revealing |0 [symbol] or |1 [symbol] .

The phase gate S is defined by

$$S = [ \begin{matrix}1 & 0 \\ 0 & {e}^{i π / 2}\end{matrix} ] . \qquad ( 81 )$$

The S gate leaves the basis state |0 [symbol] unchanged but maps |1 [symbol] to e^{iπ/2}|1 [symbol] . Accordingly, the probability of measuring either |0 [symbol] or |1 [symbol] is unchanged by this gate, but the phase of the quantum state of the qubit is shifted. This is equivalent to rotating |ψ [symbol] by 90 degrees along a circle of latitude on the Bloch sphere of FIG. 9A.

Some quantum gates operate on two or more qubits. The SWAP gate, for example, acts on two distinct qubits and swaps their values. This gate is defined by

$$SWAP = [ \begin{matrix}1 & 0 & 0 & 0 \\ 0 & 0 & 1 & 0 \\ 0 & 1 & 0 & 0 \\ 0 & 0 & 0 & 1\end{matrix} ] . \qquad ( 82 )$$

A ‘Clifford gate’ is a quantum gate that belongs to the Clifford group—viz., a set of quantum gates that effect permutations of the Pauli operators. For the n-qubit case the Pauli operators form a group

$${P}_{n} = \{ {e}^{\frac{i θ π}{2}} {σ}_{{j}_{1}} ⊗ … ⊗ {σ}_{{j}_{n}} \vert θ = 0 , 1 , 2 , 3 , {j}_{k} = 0 , 1 , 2 , 3 \} , \qquad ( 83 )$$

where σ₀, . . . σ₃ are the single-qubit Pauli matrices. The Clifford group is then defined as the group of unitaries that normalize the Pauli group,

$${C}_{n} = \{ V ∈ {U}_{{2}^{n}} \vert V {P}_{n} {V}^{†} = {P}_{n} \} . \qquad ( 84 )$$

The foregoing list of quantum gates and associated operator matrices is non-exhaustive, but is provided for ease of illustration. Other quantum gates include Pauli-X, -Y, and -Z gates, the \sqrt{NOT} gate, additional phase-shift gates, the \sqrt{SWAP} gate, controlled cX, cY, and cZ gates, and the Toffoli, Fredkin, Ising, and Deutsch gates, as non-limiting examples.

Continuing in FIG. 8, suitably configured signal from qubit writer 836 of quantum interface 834 may interact physically with one or more qubits 814 of a qubit register 812 so as to assert any desired quantum-gate operation. As noted above, the desired quantum-gate operations include specifically defined rotations of a complex vector representing a qubit register state. In some examples, in order to effect a desired rotation O, the qubit writer may apply a predetermined signal level Sᵢ for a predetermined duration Tᵢ. In some examples, plural signal levels may be applied for plural sequenced or otherwise associated durations, as shown in FIG. 9B, to assert a quantum-gate operation on one or more qubits of a qubit register. In general, each signal level Sᵢ and each duration Tᵢ is a control parameter adjustable by appropriate programming of controller 818.

The terms ‘quantum circuit’ and ‘quantum algorithm’ are used herein to describe a predetermined sequence of elementary quantum-gate and/or measurement operations executable by quantum computer 800. A quantum circuit may be used to transform the quantum state of a qubit register 812 to effect a classical or non-elementary quantum-gate operation or to apply a density operator, for example. In some examples, a quantum circuit may be used to enact a predefined operation ƒ(x), which may be incorporated into a complex sequence of operations. To ensure adjoint operation, a quantum circuit mapping n input qubits |x [symbol] to m output or auxiliary qubits |y=ƒ(x) [symbol] may be defined as a quantum gate O(|x [symbol] |y [symbol] ) operating on the (n+m) qubits. In this case, O may be configured to pass the n input qubits unchanged but combine the result of the operation ƒ(x) with the auxiliary qubits via an XOR operation, such that O(|x)⊗|y [symbol] )|x [symbol] ⊗|y⊗ƒ(x) [symbol] .

Implicit in the description herein is that each qubit 814 of any qubit register 812 may be interrogated via quantum interface 834 so as to reveal with confidence the standard basis vector |0 [symbol] or |1 [symbol] that characterizes the quantum state of that qubit. In some implementations, however, measurement of the quantum state of a physical qubit may be subject to error. Accordingly, any qubit 814 may be implemented as a logical qubit, which includes a grouping of physical qubits measured according to an error-correcting quantum algorithm or circuit that reveals the quantum state of the logical qubit with above-threshold confidence.

Due to the difficulty of isolating qubits from their noisy environment, reliable execution of large-scale quantum algorithms will almost certainly require some form of quantum error correction. A ‘stabilizer code’ is a quantum error-correction circuit that includes sets of measurements for which the parity of outcomes is predetermined in the absence of errors. The measurements function as checks of the code, which can be used to identify errors and to correct errors via classical post processing.

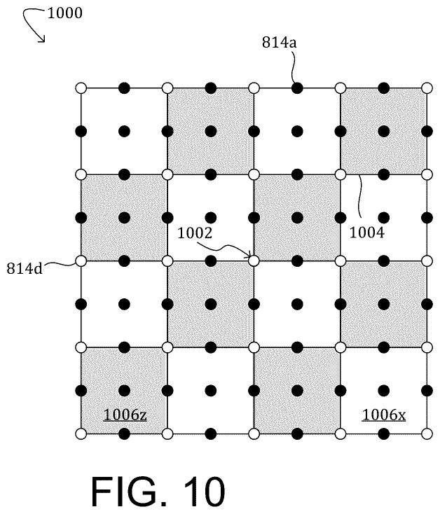

Some stabilizer codes leverage certain topological features of the qubit architecture of a quantum computer. To illustrate, FIG. 10 shows aspects of a regular lattice 1000 of physical qubits 814. In the illustrated example, lattice 1000 is a square lattice; that feature is not strictly necessary, however, as lattices of non-square and non-rectangular geometries are also envisaged. A qubit may be classified as a data qubit or as an ancillary qubit depending on how it is used. Data qubits 814D are shown as open circles in the drawings and are used to hold the evolving quantum state in a quantum computation. Ancillary qubits 814A are shown as filled circles in the drawings and are used internally by the quantum code executing on a quantum computer. In order to support quantum error correction, at least some of the information encoded in the data qubits may be stored redundantly, making use of the additional storage capacity of the ancillary qubits. In examples consonant with this disclosure, a topological stabilizer code (e.g., surface code) executes on the qubits of lattice 1000. The topological stabilizer code enacts measurements on the qubits and, in some examples, may also enact one or more quantum-gate operations.

Lattice 1000 comprises a matrix of vertices 1002, which define a set of edges 1004 and a set of plaquetes (or faces) 1006. In the topological stabilizer code, a stabilizer operator Aᵢ operates on the qubits that surround each vertex i. In addition, a stabilizer operator Bᵢ operates on the physical qubits that define each plaquete j. The ‘stabilizer space’ of the topological stabilizer code is the vector space for which each of the operators A and B reduces to the identity operator. For a surface code (as one non-limiting example), the stabilizer space is four-dimensional and capable, therefore, of representing two logical qubits of quantum information. Generally speaking, each circuit fault will move the quantum state of lattice 1000 out of the stabilizer space, resulting in vertices and faces for which operators A and or B differ from the identity operator. The positions of such anomalous operators on lattice 1000 defines the ‘syndrome’ of the topological error-correcting quantum code, which can be used for error correction. In this process, a decoder program executing on a classical computer maps the syndrome to a series of bit flips, which may be applied to the measured output of a quantum algorithm, to yield an error-free result. Because the stabilizer code controls how the syndrome maps to the required bit flips, it also controls the build of the classical decoder. Currently, decoders based on topological stabilizer codes are the most efficient. For additional information, the interested reader is referred to the extensive literature on topological stabilizer codes.

With continued reference to FIG. 10, the measurement circuits of a topological stabilizer code are applied in sequence to one or more plaquetes of a qubit lattice as the code executes. Because neighboring plaquetes share qubits, and because any measurement on a given qubit can be made only once, there are a limited number of ways to extend the qubit measurements over the entire lattice, plaquet by plaquet. The available alternatives may be further constrained in scenarios where it is important to interrogate the entire lattice as rapidly as possible, in order to limit the decoherence that may occur between measurements.

FIG. 11 schematically shows a non-limiting embodiment of a computing system 1100 that can enact one or more of the methods and processes described above. Computing system 1100 is shown in simplified form. Computing system 1100 may embody classical computing device 320 described above and illustrated in FIG. 3. Components of computing system 1100 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 1100 includes a logic processor 1102, volatile memory 1104, and a non-volatile storage device 1106. Computing system 1100 may optionally include a display subsystem 1108, input subsystem 1110, communication subsystem 1112, and/or other components not shown in FIG. 11.

Logic processor 1102 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 1102 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1106 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 1106 may include physical devices that are removable and/or built in. Non-volatile storage device 1106 may include optical memory, semiconductor memory, and/or magnetic memory, or other mass storage device technology. Non-volatile storage device 1106 may include nonvolatile, dynamic, static, read/write, read-only, sequential-access, location-addressable, file-addressable, and/or content-addressable devices. It will be appreciated that non-volatile storage device 1106 is configured to hold instructions even when power is cut to the non-volatile storage device 1106.

Volatile memory 1104 may include physical devices that include random access memory. Volatile memory 1104 is typically utilized by logic processor 1102 to temporarily store information during processing of software instructions. It will be appreciated that volatile memory 1104 typically does not continue to store instructions when power is cut to the volatile memory 1104.

Aspects of logic processor 1102, volatile memory 1104, and non-volatile storage device 1106 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1100 typically implemented in software by a processor to perform a particular function using portions of volatile memory, which function involves transformative processing that specially configures the processor to perform the function. Thus, a module, program, or engine may be instantiated via logic processor 1102 executing instructions held by non-volatile storage device 1106, using portions of volatile memory 1104. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1108 may be used to present a visual representation of data held by non-volatile storage device 1106. The visual representation may take the form of a graphical user interface (GUI). As the herein described methods and processes change the data held by the non-volatile storage device, and thus transform the state of the non-volatile storage device, the state of display subsystem 1108 may likewise be transformed to visually represent changes in the underlying data. Display subsystem 1108 may include one or more display devices utilizing virtually any type of technology. Such display devices may be combined with logic processor 1102, volatile memory 1104, and/or non-volatile storage device 706 in a shared enclosure, or such display devices may be peripheral display devices.

When included, input subsystem 1110 may comprise or interface with one or more user-input devices such as a keyboard, mouse, touch screen, camera, or microphone.

When included, communication subsystem 1112 may be configured to communicatively couple various computing devices described herein with each other, and with other devices. Communication subsystem 1112 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 1100 to send and/or receive messages to and/or from other devices via a network such as the Internet.

In one example, a method for a quantum computer is presented. The method comprises receiving a target matrix comprising only real eigenvalues; presenting the target matrix as block encoding; precomputing a polynomial approximation for a function to be applied to the target matrix; selecting coefficients for a generating function that match the precomputed polynomial approximation; and generating a polynomial history state comprising a superposition of polynomials onto the block encoded target matrix by at least mapping the generating function to a quantum algorithm. In such an example, or any other example, the polynomial approximation is additionally or alternatively a Chebyshev polynomial. In any of the preceding examples, or any other example, the target matrix is additionally or alternatively a diagonalizable matrix. In any of the preceding examples, or any other example, the target matrix is additionally or alternatively a non-Hermitian matrix. In any of the preceding examples, or any other example, the method additionally or alternatively comprises generating an eigenvalue estimation for the function based on the polynomial history state. In any of the preceding examples, or any other example, the method additionally or alternatively comprises applying an inverse quantum Fourier transform to the function and measuring an ancilla register; using the ancilla register measurement to compute an initial estimate of an eigenvalue; determining whether the number of initial estimates has reached a target repetition number; computing a median of all initial estimates responsive to the number of samples increasing to a target repetition number; and outputting the median as the estimated eigenvalue. In any of the preceding examples, or any other example, the method additionally or alternatively comprises, responsive to the number of initial estimates being below the target repetition number, preparing an additional polynomial history state. In any of the preceding examples, or any other example, the polynomial history state is additionally or alternatively utilized to apply polynomial functions to the eigenvalues of non-normal matrices via a quantum eigenvalue transformation. In any of the preceding examples, or any other example, the method additionally or alternatively comprises receiving a polynomial function having a polynomial expansion, wherein coefficients of the polynomial history state are based on the polynomial function; performing amplitude amplification on the function based on the polynomial history state; repeating the amplitude amplification for a number of rounds based on a ratio of a shifted partial sum and a desired state; and outputting the eigenvalue transformation based on the repeated amplitude amplification.

In another example, a quantum computing system is presented. The quantum computing system comprises processing hardware configured to receive a target matrix comprising only real eigenvalues; present the target matrix as block encoding; precompute a polynomial approximation for a function to be applied to the target matrix; select coefficients for a generating function that match the precomputed polynomial approximation; and generate a polynomial history state comprising a superposition of polynomials onto the block encoded target matrix by at least mapping the generating function to a quantum algorithm. In such an example, or any other example, the polynomial approximation is additionally or alternatively a Chebyshev polynomial. In any of the preceding examples, or any other example, the target matrix is additionally or alternatively a diagonalizable matrix. In any of the preceding examples, or any other example, the target matrix is additionally or alternatively a non-Hermitian matrix. In any of the preceding examples, or any other example, the processing hardware is additionally or alternatively configured to generate an eigenvalue estimation for the function based on the polynomial history state. In any of the preceding examples, or any other example, the processing hardware is additionally or alternatively configured to apply an inverse quantum Fourier transform to the function and measuring an ancilla register; use the ancilla register measurement to compute an initial estimate of an eigenvalue; determine whether the number of initial estimates has reached a target repetition number; compute a median of all initial estimates responsive to the number of samples increasing to a target repetition number; and output the median as the estimated eigenvalue. In any of the preceding examples, or any other example, the processing hardware is additionally or alternatively configured to, responsive to the number of initial estimates being below the target repetition number, prepare an additional polynomial history state. In any of the preceding examples, or any other example, the polynomial history state is additionally or alternatively utilized to apply polynomial functions to the eigenvalues of non-normal matrices via a quantum eigenvalue transformation. In any of the preceding examples, or any other example, the processing hardware is additionally or alternatively configured to receive a polynomial function having a polynomial expansion, wherein coefficients of the polynomial history state are based on the polynomial function; perform amplitude amplification on the function based on the polynomial history state; repeat the amplitude amplification for a number of rounds based on a ratio of a shifted partial sum and a desired state; and output the eigenvalue transformation based on the repeated amplitude amplification.

In yet another example, a method for preparing a Chebyshev history state is presented. The method comprises receiving a diagonalizable matrix A comprising only real eigenvalues; block encoding

$$I ⊗ I + {L}^{2} ⊗ I - 2 L ⊗ \frac{A}{{α}_{A}}$$

to generate a first component, where L is a n-by-n lower shift matrix and α_{A} is a normalization factor ≥2∥A∥; receiving a set of coefficients \tilde{β}; reversing the set of coefficients and applying I⊗I−L²⊗I to generate a second component; receiving, as a third component, an initial state ψ; and applying a quantum linear system algorithm to the first, second, and third components to generate the Chebyshev history state. In such an example, or any other example, the diagonalizable matrix A is additionally or alternatively a non-Hermitian matrix.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for a quantum computer, comprising:
receiving a target matrix comprising only real eigenvalues;
presenting the target matrix as block encoding;
precomputing a polynomial approximation for a function to be applied to the target matrix;
selecting coefficients for a generating function that match the precomputed polynomial approximation; and
generating a polynomial history state comprising a superposition of polynomials onto the block encoded target matrix by at least mapping the generating function to a quantum algorithm.

2. The method of claim 1, wherein the polynomial approximation is a Chebyshev polynomial.

3. The method of claim 1, wherein the target matrix is a diagonalizable matrix.

4. The method of claim 3, wherein the target matrix is a non-Hermitian matrix.

5. The method of claim 1, further comprising:
generating an eigenvalue estimation for the function based on the polynomial history state.

6. The method of claim 5, further comprising:
applying an inverse quantum Fourier transform to the function and measuring an ancilla register;
using the ancilla register measurement to compute an initial estimate of an eigenvalue;
determining whether the number of initial estimates has reached a target repetition number;
computing a median of all initial estimates responsive to the number of samples increasing to a target repetition number; and
outputting the median as the estimated eigenvalue.

7. The method of claim 6, further comprising:
responsive to the number of initial estimates being below the target repetition number, preparing an additional polynomial history state.

8. The method of claim 1, wherein the polynomial history state is utilized to apply polynomial functions to the eigenvalues of non-normal matrices via a quantum eigenvalue transformation.

9. The method of claim 8, further comprising:
receiving a polynomial function having a polynomial expansion, wherein coefficients of the polynomial history state are based on the polynomial function;
performing amplitude amplification on the function based on the polynomial history state;
repeating the amplitude amplification for a number of rounds based on a ratio of a shifted partial sum and a desired state; and
outputting the eigenvalue transformation based on the repeated amplitude amplification.

10. A quantum computing system, comprising:
processing hardware configured to:
receive a target matrix comprising only real eigenvalues;
present the target matrix as block encoding;
precompute a polynomial approximation for a function to be applied to the target matrix;
select coefficients for a generating function that match the precomputed polynomial approximation; and
generate a polynomial history state comprising a superposition of polynomials onto the block encoded target matrix by at least mapping the generating function to a quantum algorithm.

11. The quantum computing system of claim 10, wherein the polynomial approximation is a Chebyshev polynomial.

12. The quantum computing system of claim 10, wherein the target matrix is a diagonalizable matrix.

13. The quantum computing system of claim 12, wherein the target matrix is a non-Hermitian matrix.

14. The quantum computing system of claim 10, wherein the processing hardware is further configured to:
generate an eigenvalue estimation for the function based on the polynomial history state.

15. The quantum computing system of claim 14, wherein the processing hardware is further configured to:
apply an inverse quantum Fourier transform to the function and measuring an ancilla register;
use the ancilla register measurement to compute an initial estimate of an eigenvalue;
determine whether the number of initial estimates has reached a target repetition number;
compute a median of all initial estimates responsive to the number of samples increasing to a target repetition number; and
output the median as the estimated eigenvalue.

16. The quantum computing system of claim 15, wherein the processing hardware is further configured to:
responsive to the number of initial estimates being below the target repetition number, prepare an additional polynomial history state.

17. The quantum computing system of claim 10, wherein the polynomial history state is utilized to apply polynomial functions to the eigenvalues of non-normal matrices via a quantum eigenvalue transformation.

18. The quantum computing system of claim 17, wherein the processing hardware is further configured to:
receive a polynomial function having a polynomial expansion, wherein coefficients of the polynomial history state are based on the polynomial function;
perform amplitude amplification on the function based on the polynomial history state;
repeat the amplitude amplification for a number of rounds based on a ratio of a shifted partial sum and a desired state; and
output the eigenvalue transformation based on the repeated amplitude amplification.

19. A method for preparing a Chebyshev history state, comprising:
receiving a diagonalizable matrix A comprising only real eigenvalues;
block encoding
$$I ⊗ I + {L}^{2} ⊗ I - 2 L ⊗ \frac{A}{{α}_{A}}$$
to generate a first component, where L is a n-by-n lower shift matrix and α_{A} is a normalization factor ≥2∥A∥;
receiving a set of coefficients \tilde{β};
reversing the set of coefficients and applying I⊗I −L²⊗I to generate a second component;
receiving, as a third component, an initial state ψ; and
applying a quantum linear system algorithm to the first, second, and third components to generate the Chebyshev history state.

20. The method of claim 19, wherein the diagonalizable matrix A is a non-Hermitian matrix.
